(19) United States
(12) Patent Application Publication
(10) Pub. No.: US 2021/0237342 A1
(43) Pub. Date: Aug. 5, 2021

(54) Cross-Linkable Thermoplastic Polymeric Materials for Use in Additive Manufacturing

(71) Applicant: Arevo, Inc., Milpitas, CA (US)

(72) Inventors: Sanjiv Bhatt, San Jose, CA (US); Hemant Bheda, Saratoga, CA (US)

(73) Assignee: Arevo, Inc., Milpitas, CA (US)

(21) Appl. No.: 16/768,894

(22) PCT Filed: Mar. 18, 2019
(86) PCT No.: PCT/US2019/022815

§ 371 Date: Jun. 2, 2020

Related U.S. Application Data
(60) Provisional application No. 62/644,927, filed on Mar. 19, 2018.

(51) Int. Cl. B29C 64/118; B33Y 10/00; B33Y 30/00; B33Y 50/02; B29C 64/393

(52) U.S. Cl. CPC B29C 64/118; B33Y 10/00; B29K 2105/08; B33Y 50/02; B29C 64/393; B33Y 30/00

(57) ABSTRACT

The present disclosure provides methods and systems for fabricating at least a portion of a three-dimensional (3D) object. In an example, at least one feedstock may be directed from a source of the at least one feedstock towards a base. The at least one feedstock may comprise a polymeric material and a cross-linking agent. The cross-linking agent may be in an inactive state. Next, first layer of the at least one feedstock may be deposited adjacent to a second layer previously deposited adjacent to the base. The first layer may correspond to at least a portion of the 3D object. During or subsequent to deposition adjacent to the second layer, the cross-linking agent in the first layer may be in an active state to induce cross-linking between the polymeric material in the first layer and a polymeric material in the second layer.

### CROSS-REFERENCE TO RELATED APPLICATIONS

This application claims the benefit of U.S. Provisional Patent Application No. 62/644,927, filed Mar. 19, 2018, which is incorporated herein by reference.

This application is a 35 U.S.C. 371 nation filing of, and claims priority to, Patent Cooperation Treaty International Application Number PCT/US2019/022815, with the International Filing Date of Mar. 18, 2019, which application is incorporated by reference.

### BACKGROUND

Additive manufacturing has been utilized for fabricating three-dimensional parts by depositing successive layers of material in an automated manner. Techniques of additive manufacturing include, without limitation, fused deposition modeling (FDM), fused filament fabrication (FFF), Plastic Jet Printing (PJP), extrusion-based techniques, jetting, selective laser sintering, powder/binder jetting, electron-beam melting, and stereolithographic processes. Using these techniques, a material (e.g., a heated and/or pressurized thermoplastic) may pass through a print head. The print head may be moved in a predefined trajectory (e.g., a tool path) as the material discharges from the print head, such that the material is laid down in a particular pattern and shape of overlapping layers. The material, after exiting the print head, may harden into the finished form.

### SUMMARY

In an aspect, the present disclosure provides a method for fabricating at least a portion of a three-dimensional (3D) object, comprising (a) directing at least one feedstock from a source of the at least one feedstock towards a base; and (b) depositing a first layer of the at least one feedstock adjacent to a second layer previously deposited adjacent to the base. In some embodiments, the at least one feedstock comprises a polymeric material and a cross-linking agent, which cross-linking agent is in an inactive state. The first layer may correspond to at least a portion of the 3D object. In some embodiments, during or subsequent to deposition adjacent to the second layer, the cross-linking agent in the first layer is in an active state to induce cross-linking between the polymeric material in the first layer and a polymeric material in the second layer.

In some embodiments, the second layer is formed from the at least one feedstock. The second layer may comprise the cross-linking agent and the polymeric material. In some embodiments, the cross-linking agent of the second layer is in an active state subsequent to deposition. In some embodiments, the method for fabricating at least a portion of the 3D object further comprises repeating (b) one or more times for deposition of additional layer(s) to form the 3D object. In some embodiments, the method for fabricating at least a portion of the 3D object further comprises, prior to (a), combining the cross-linking agent with the polymeric material in the inactive state to form the at least one feedstock. In some embodiments, the method for fabricating at least a portion of the 3D object further comprises impregnating a thermo-initiator or a photo-initiator into the at least one feedstock. In some embodiments, the at least one feedstock comprises an initiator. In some embodiments, the initiator is a thermo-initiator or a photo-initiator. In some embodiments, the at least one feedstock does not comprise an initiator.

In some embodiments, the at least one feedstock is a continuous fiber composite. In some embodiments, the polymeric material is an unpolymerized resin or a partially polymerized resin. In some embodiments, the polymeric material comprises one or more elements selected from the group consisting of polyethylene, polyamide, polybutylene terephthalate, polyvinyl chloride, polypropylene, and thermoplastic elastomer. In some embodiments, cross-linking agent comprises one or more elements selected from the group consisting of organo-functional silane, phenylene diamine, and triallyl cyanurate (TAC).

In some embodiments, the fabricating is selected from the group consisting of direct energy deposition, fused deposition modeling, selective laser sintering, and stereolithography. In some embodiments, the cross-linking agent is activated by a predetermined amount of heat or radiation from an energy source. In some embodiments, the radiation is gamma radiation or electron beam radiation. In some embodiments, the at least the portion of the 3D object is shielded from the heat or the radiation. In some embodiments, the at least one feedstock comprises an inhibiting agent that shields at least a portion of the at least one feedstock from the heat or the radiation.

In another aspect, the present disclosure provides a method for fabricating at least a portion of a three-dimensional (3D) object, comprising: (a) using a fabricating unit to direct at least one feedstock from a source of the at least one feedstock towards a base, wherein the at least one feedstock comprises a polymeric material and a cross-linking agent, which cross-linking agent is in an inactive state; and (b) using the fabricating unit to deposit a first layer of the at least one feedstock adjacent to a second layer previously deposited adjacent to the base, wherein the first layer corresponds to at least a portion of the 3D object, wherein during or subsequent to deposition adjacent to the second layer, the cross-linking agent in the first layer is in an active state to induce cross-linking between the polymeric material in the first layer and a polymeric material in the second layer.

In some embodiments, the second layer is formed from the at least one feedstock, and wherein the second layer comprises the cross-linking agent and the polymeric material, wherein the cross-linking agent of the second layer is in an active state subsequent to deposition. In some embodiments, the method for fabricating at least a portion of the 3D object further comprises repeating (b) one or more times for deposition of additional layer(s) to form the 3D object. In some embodiments, the method for fabricating at least a portion of the 3D object further comprises, prior to (a), combining the cross-linking agent with the polymeric material in the inactive state to form the at least one feedstock. In some embodiments, combining the cross-linking agent with the polymeric material in the inactive state to form the at least one feedstock further comprises impregnating a thermo-initiator or a photo-initiator into the at least one feedstock.

In some embodiments, the at least one feedstock comprises an initiator. In some embodiments, the initiator is a thermo-initiator or a photo-initiator. In some embodiments, the at least one feedstock does not comprise an initiator. In some embodiments, the at least one feedstock is a continuous fiber composite. In some embodiments, the polymeric material is an unpolymerized resin or a partially polymerized resin. In some embodiments, the polymeric material comprises one or more elements selected from the group consisting of polyethylene, polyamide, polybutylene terephthalate, polyvinyl chloride, polypropylene, and thermoplastic elastomer. In some embodiments, the cross-linking agent comprises one or more elements selected from the group consisting of organo-functional silane, phenylene diamine, and triallyl cyanurate (TAC).

In some embodiments, the fabricating is selected from the group consisting of direct energy deposition, fused deposition modeling, selective laser sintering, and stereolithography. In some embodiments, the cross-linking agent is activated by a predetermined amount of heat or radiation from an energy source. In some embodiments, the radiation is gamma radiation or electron beam radiation. In some embodiments, the at least the portion of the 3D object is shielded from the heat or the radiation. In some embodiments, the at least one feedstock comprises an inhibiting agent that shields at least a portion of the at least one feedstock from the heat or the radiation.

In another aspect, the present disclosure provides a system for fabricating at least a portion of a three-dimensional (3D) object, comprising: a source of at least one feedstock that is configured to supply at least one feedstock for generating the at least the portion of the 3D object; a base for supporting the at least the portion of the 3D object; a fabricating unit that is configured to direct the at least one feedstock from the source of the at least one feedstock towards the base; and one or more computer processors operatively coupled to the fabricating unit, wherein the one or more computer processors are individually or collectively programmed to: (i) direct the fabricating unit to direct the at least one feedstock from the source of the at least one feedstock towards the base, wherein the at least one feedstock comprises a polymeric material and a cross-linking agent, which cross-linking agent is in an inactive state, and (ii) direct the fabricating unit to deposit a first layer of the at least one feedstock adjacent to a second layer previously deposited adjacent to the base, wherein the first layer corresponds to the at least the portion of the 3D object, wherein during or subsequent to deposition adjacent to the second layer, the cross-linking agent in the first layer is in an active state to induce cross-linking between the polymeric material in the first layer and a polymeric material in the second layer.

In some embodiments, the one or more computer processors are individually or collectively programmed to repeat (ii) one or more times for deposition of additional layer(s) to form the at least the portion of the 3D object. In some embodiments, the at least one feedstock comprises an initiator. In some embodiments, the initiator is a thermo-initiator or a photo-initiator. In some embodiments, the at least one feedstock does not comprise an initiator. In some embodiments, the at least one feedstock is a continuous fiber composite. In some embodiments, the polymeric material is an unpolymerized resin or a partially polymerized resin. In some embodiments, the polymeric material comprises one or more elements selected from the group consisting of polyethylene, polyamide, polybutylene terephthalate, polyvinyl chloride, polypropylene, and thermoplastic elastomer. In some embodiments, the cross-linking agent comprises one or more elements selected from the group consisting of organo-functional silane, phenylene diamine, and triallyl cyanurate (TAC).

In some embodiments, the fabricating is selected from the group consisting of direct energy deposition, fused deposition modeling, selective laser sintering, and stereolithography. In some embodiments, the one or more computer processors are individually or collectively programmed to use an energy source to direct a predetermined amount of heat or radiation to activate the cross-linking agent. In some embodiments, the radiation is gamma radiation or electron beam radiation. In some embodiments, the at least the portion of the 3D object is shielded from the heat or the radiation. In some embodiments, the at least one feedstock comprises an inhibiting agent that shields at least a portion of the at least one feedstock from the heat or the radiation.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows an example system that may be used to produce a three-dimensional object having any shape, size, and structure using an energy source and compaction unit;

FIG. 2 shows an exemplary reaction scheme for formation of interlayer crosslinks;

FIG. 3 shows schematic of cross-links across the boundaries of layers;

FIG. 4 shows a computer control system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

As used herein, the singular forms “a,” “an,” and “the” include plural references unless the context clearly dictates otherwise. Any reference to “or” herein is intended to encompass “and/or” unless otherwise stated.

The term “branched”, as used herein, generally refers to a polymer with more than two end groups.

The term “three-dimensional printing” (also “3D printing”), as used herein, generally refers to a process or method for fabricating a three-dimensional (3D) part (or object). For example, 3D printing may refer to sequential addition of material layer or joining of material layers or parts of material layers to form a 3D part, object, or structure, in a controlled manner (e.g., under automated control). In the 3D printing process, the deposited material can be fused, sintered, melted, bound or otherwise connected to form at least a part of the 3D object. Fusing the material may include melting or sintering the material. Binding can comprise chemical bonding. Chemical bonding can comprise covalent bonding. Examples of 3D printing include additive printing (e.g., layer by layer printing, or additive manufacturing) and subtractive printing.

The term “object,” as used herein, generally refers to any object that may be formed by 3D printing. An object may be fabricated using 3D printing methods and systems of the present disclosure. An object may be a portion of a larger part or structure, or an entirety of a part or structure. An object may have various form factors, as may be based on a model of such object.

The term “composite material,” as used herein, generally refers to a material formed from two or more constituent materials. Such two or more constituent materials may be different materials, such as, for example, a polymeric material and a non-polymeric material (e.g., carbon fibers). The two or more constituent materials may have different physical or chemical properties that, when combined, produce a material with characteristics different from the individual components.

The term “fuse”, as used herein, generally refers to binding, agglomerating, or polymerizing. Fusing may include melting, softening or sintering (e.g., not complete melting). Binding may comprise chemical binding. Chemical binding may include covalent binding. Materials may be fused using energy supplied by one or more energy sources. Such energy may be supplied by a laser, a microwave source, resistive heating, an infrared energy (IR) source, a ultraviolet (UV) energy source, hot fluid (e.g., hot air), a chemical reaction, a plasma source, an electron beam, a particle beam, or a combination thereof. The energy may be supplied by electromagnetic energy, such as from a laser, IR source, or UV source. A source for resistive heating may be a power supply. The hot fluid can have a temperature greater than 25° C., or greater than or equal to about 40° C., 50° C., 60° C., 70° C., 80° C., 90° C., 100° C., 150° C., 200° C., 250° C., 300° C., 350° C., 400° C., 450° C., 500° C., or higher. The hot fluid may have a temperature that is selected to soften or melt a material used to print an object. The hot fluid may have a temperature that is at or above a melting point or glass transition point of a polymeric material. The hot fluid can be a gas or a liquid. In some examples, the hot fluid is air.

The term “adjacent” or “adjacent to,” as used herein, generally refers to ‘on,’ ‘over, ‘next to,’ ‘adjoining,’ ‘in contact with,’ or ‘in proximity to.’ In some cases, adjacent components are separated from one another by one or more intervening layers. The one or more intervening layers may have a thickness less than about 1000 micrometers (“microns”), 900 micron, 800 micron, 700 micron, 600 micron, 500 micron, 400 micron, 300 micron, 200 micron, 100 micron, 90 micron, 80 micron, 70 micron, 60 micron, 50 micron, 40 micron, 30 micron, 20 micron, 10 micron, 1 micron, 500 nanometers (“nm”), 100 nm, 50 nm, 10 nm, 1 nm, 0.5 nm or less. For example, a first layer adjacent to a second layer can be on or in direct contact with the second layer. As another example, a first layer adjacent to a second layer can be separated from the second layer by at least one third layer.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Examples of 3D printing methodologies comprise wire, granular, laminated, light polymerization, VAT photopolymerization, material jetting, binder jetting, sheet lamination, directed energy deposition, extrusion, power bed and inkjet-based 3D printing. 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Power bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP) or laminated object manufacturing (LOM).

In an aspect, the present disclosure provides a method for fabricating at least a portion of a three-dimensional (3D) object. The method may comprise directing (e.g., using a fabricating unit) at least one feedstock from a source of the at least one feedstock towards a base. The feedstock can comprise a polymeric material and/or a cross-linking agent. The cross-linking agent may be in an inactive state prior to deposition of the feedstock on the base. A first layer of the feedstock may be deposited adjacent to the base. Next, a second layer of the at least one feedstock may be deposited (e.g., using a fabricating unit) adjacent to the first layer previously deposited adjacent to the base. The second layer can correspond to at least a portion of the 3D object. During or subsequent to deposition adjacent to the first layer, the cross-linking agent in the first layer and/or second layer may be activated to induce cross-linking between the polymeric material in the first layer and the polymeric material in the second layer. Additional deposition (e.g., using a fabricating unit) of one or more layers in an inactive and/or active state may be performed to form the 3D object.

In some cases, the first layer may be physically and/or chemically bonded to the base so that the 3D object and base remain together. The base may be a previously deposited layer of the 3D object or at least one sacrificial layer prior to deposition of one or more layers as part of the 3D object.

Prior to activation, the polymeric material may be heated to at or above its melting temperature and maintained at this temperature for a time sufficient to allow the polymer chains to achieve an entangled state. A sufficient time period may be at least about 10 seconds, at least about 30 seconds, at least about 1 minute (min), at least about 5 min, at least about 10 min, at least about 20 min, at least about 30 min, at least about 60 min, at least about 2 hours (hr), at least about 3 hr, or more. Alternatively, the sufficient time period may be at most about 5 hrs, at most about 3 hrs, at most about 2 hrs, at most about 60 min, at most about 30 min, at most about 20 min, at most about 10 min, at most about 5 min, at most about 1 min, at most about 30 seconds, at most about 10 seconds, or less.

The cross-linking agent may be activated prior to deposition, during deposition, and/or subsequent to deposition of one or more layers of the 3D object. For example, the cross-linking agent may be activated after deposition of the first layer and prior to deposition of the second layer. Alternatively, the cross-linking agent may be activated after deposition of the first layer and the second layer (e.g., consecutive deposition of the first and second layer two layers followed by activation of the first and second layer to induce inter-layer adhesion).

In some cases, the cross-linking agent may be activated in at least a portion of a deposited layer. At least a portion of the first layer, the second layer, and/or a subsequently deposited layer may be shielded from activation to generate at least a shielded portion of the first layer and/or the second layer and/or at least a non-shielded portion of the first layer and/or the second layer. The shielded portion of the first layer, the second layer, and/or a subsequently deposited layer may comprise a material selected from the group consisting of ceramics, metals, glass and polymers. The shielded portion of the first layer and/or second layer may comprise one or more light absorbers. The non-shielded portion of the first layer and/or the second layer may be activated for cross-linking.

The 3D object may be printed using various approaches, such as direct energy deposition, fused deposition modeling, fused filament fabrication, selective laser sintering, selective laser melting, stereolithography, direct metal laser sintering, electron beam melting, laminated object manufacturing, laser powder forming printing, polyjet printing, material jetting, or syringe extrusion. In some cases, a 3D printer may be independently selected during each fabricating step associated with the method for fabricating at least a portion of the 3D object. For example, different 3D printers may be utilized to impart different characteristics with respect to the layers.

In another aspect, the present disclosure provides a system for fabricating at least a portion of a three-dimensional (3D) object, comprising a source of at least one feedstock that is configured to supply at least one feedstock for generating the at least the portion of the 3D object; a base for supporting the at least the portion of the 3D object; a fabricating unit that is configured to direct the at least one feedstock from the source of the at least one feedstock towards the base; and/or one or more computer processors operatively coupled to the fabricating unit. The one or more computer processors may be individually or collectively programmed to (i) direct the fabricating unit to direct the at least one feedstock from the source of the at least one feedstock towards the base. The at least one feedstock may comprise a polymeric material and a cross-linking agent, which cross-linking agent is in an inactive state. The one or more computer processors may be individually or collectively programmed to (ii) direct the fabricating unit to deposit a first layer of the at least one feedstock adjacent to a second layer previously deposited adjacent to the base, wherein the first layer corresponds to the at least the portion of the 3D object. During or subsequent to deposition adjacent to the second layer, the cross-linking agent in the first layer may be in an active state to induce cross-linking between the polymeric material in the first layer and a polymeric material in the second layer.

In some cases, the one or more computer processors are individually or collectively programmed to repeat (ii) one or more times for deposition of additional layer(s) to form the at least the portion of the 3D object. The at least one feedstock may comprise an initiator. In some cases, the initiator may be a thermo-initiator or a photo-initiator. In some cases, the at least one feedstock does not comprise an initiator. The at least one feedstock may be a continuous fiber composite.

The polymeric material may be an unpolymerized resin or a partially polymerized resin. The polymeric material can comprise one or more elements selected from the group consisting of polyethylene, polyamide, polybutylene terephthalate, polyvinyl chloride, polypropylene, and thermoplastic elastomer. The cross-linking agent may comprise one or more elements selected from the group consisting of organo-functional silane, phenylene diamine, and triallyl cyanurate (TAC). The fabricating may be selected from the group consisting of direct energy deposition, fused deposition modeling, selective laser sintering, and stereolithography. In some cases, the one or more computer processors can be individually or collectively programmed to use an energy source to direct a predetermined amount of heat or radiation to activate the cross-linking agent. The radiation may be gamma radiation or electron beam radiation. The at least the portion of the 3D object can be shielded from the heat or the radiation. In some cases, the at least one feedstock may comprise an inhibiting agent that shields at least a portion of the at least one feedstock from the heat or the radiation.

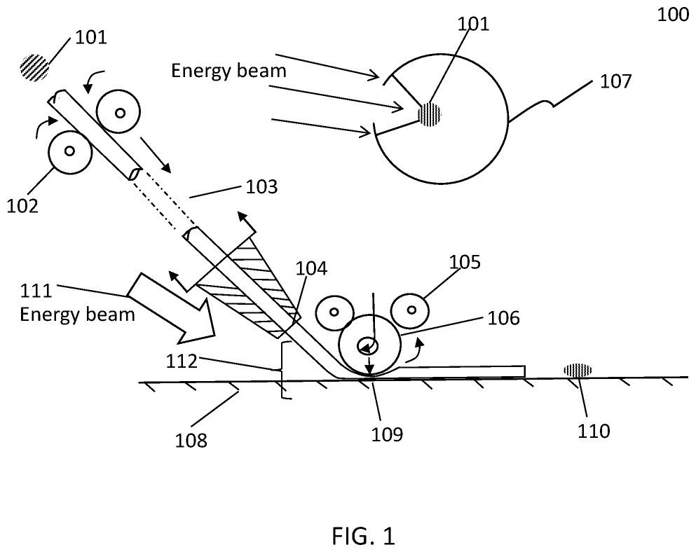

FIG. 1 illustrates an example system 100, which may be used to print a 3D object having any predetermined shape, size, structure, or configuration. System 100 may include an extender mechanism (or unit) 102 comprising one or more rollers for directing at least one feedstock 103 along a feedstock deposition pathway from a source of at least one feedstock material towards a base 108. The extender mechanism can include a motor for dispensing at least one feedstock. The feedstock 103 may initially comprise an uncompressed cross section 101.

Next, the feedstock 103 may be directed along the feedstock deposition pathway from the source to an opening 104, such as a nozzle. The opening 104 may receive the feedstock 103, and can then direct the feedstock 103 towards the base 108. The base 108 may be adjacent the 3D object once formed.

The feedstock 103 may be directed into the opening at an angle such that it is fed under at least one freely suspended roller 106 of a compaction unit at a nip point 109. The compaction unit may comprise the at least one freely suspended roller 106 that is supported by one or more idler rollers 105. The nip point 109 may be the position where the feedstock 103 meets the base 108 and is pressed by the at least one freely suspended roller 106 to form a deposited layer with a compressed cross section 110.

The opening 104 can be part of a print head. The print head can be movable relative to the base 108. Additionally or as an alternative, the base 108 can be movable relative to the print head. For example, the base can include a drive mechanism (or unit) for moving the base 108 relative to the print head.

The feedstock 103 may be used to form the 3D object. As an alternative or in addition to, the feedstock 103 may be used to form one or more layers for coupling the 3D object to the base (e.g., such one or more layers may be sacrificial layers).

Upon leaving the opening 104, the feedstock 103 may be directed to the at least one freely suspended roller 106. This may aid in depositing a layer corresponding to a portion of the 3D object on the base 108 or at least one sacrificial layer prior to deposition of one or more layers as part of the 3D object. The next layer corresponding to the portion of the 3D object or of at least a portion of the sacrificial layers of the 3D object may then be deposited. During deposition, the roller 106 can move along a direction from right to left in the context of FIG. 1. The roller may be moved from left to right, such as to deposit in the opposite direction or to compact the one or more layers that has been deposited. The at least one freely suspended roller 106 may be configured to control the bend radii of the feedstock 103 during deposition of the layer corresponding to the portion of the 3D object.

At least one energy beam 111 (e.g., a laser beam) from at least one energy source may selectively heat and/or activate at least a portion of the first layer and/or the second layer, thereby forming at least a portion of the 3D object. As an alternative or in addition to, the at least one energy beam 111 from the at least one energy source may selectively heat and/or activate at least a portion of the feedstock being deposited and a previously deposited layer of the 3D object (or other support such as the sacrificial raft). This heating and/or activation of both the feedstock and the previously deposited layer may result in greater mixing of the feedstock and the previously deposited layer. This heating and/or activation of both the feedstock and the previously deposited layer may also result in cross layer cross-linking resulting in greater adhesion between the feedstock and the previously deposited layer. At least a portion of the 3D object may be generated from the feedstock 103 continuously upon subjecting the deposited feedstock 103 to heating and/or activation along one or more locations of the feedstock deposition pathway.

In some examples, the first layer is deposited adjacent to the base 108 using the at least one feedstock 103. Next, the second layer is deposited adjacent to the first layer. The second layer may be deposited using the at least one feedstock or at least one other feedstock material (e.g., in situations in which the feedstock material is to be alternated). While the second layer is deposited, an energy beam 111 from at least one energy source may heat and/or activate at least a portion of the first layer and at least a portion of the feedstock being used to deposit the second layer. Such heating and/or activation may be implemented using a defocused energy beam directed to both at least a portion of the first layer and the at least the portion of the feedstock being used to deposit the second layer. The at least one energy beam 111 may be directed to area 112. The at least one energy beam 111 may heat and/or activate at least the portion of the first layer and at least the portion of the feedstock being used to deposit the second layer. The roller 106 may be used to compact such heated and/or activated portions of the first layer and the feedstock being deposited to form the second layer. As an alternative or in addition to using an energy beam, other sources of energy may be used, such as a hot fluid or resistive heating.

The at least one energy source may be a laser head that is mounted on a six axis or seven axis robot (e.g., a six axis or seven axis robotic arm) or similar mechanism that swivels around any axis enabling deposition in any direction in the plane of deposition. The system 100 may further comprise a controller operatively coupled to at least one energy source and the print head. The controller may be used to control various aspects of fabricating the 3D object, such as, for example, directing feedstock to the print head, directing movement of the print head, and directing the at least one energy source to supply the energy beam 111.

In some cases, the at least one feedstock may be a continuous fiber composite. The continuous fiber composite may be a continuous fiber thermoplastic tow preg. The feedstock may be formed by combining one or more elements selected from the group consisting of cross-linking agent, polymeric material, fiber reinforcement, and/or one or more polymerizing reagents. The polymeric material may be an unpolymerized resin or a partially polymerized resin. The polymeric material may be a thermoplastic. The polymerizing reagent may be an initiator and/or polymerization catalyst. In some cases, the polymerizing reagent may comprise monomers and/or oligomers.

The cross-linking agent may be a compound (e.g. vinyl silane) that comprises two or more reactive ends chemically attaching to specific functional groups of nearby molecules (e.g., polymeric chains), thereby forming crosslinks between polymer chains. In some cases, the cross-linking agent may comprise one or more elements selected from the group consisting of organo-functional silane, phenylene diamine, and triallyl cyanurate (TAC). A cross-linking density of the cross-linking agent may be controlled to produce predetermined mechanical property such as viscosity, viscoelasticity, rigidity, or glassiness. The cross-linking agent may comprise an activation temperature for the initiation of cross-linking. In some cases, an inactive state may formed in the presence of a temperature that is less than the activation temperature of the cross-linking agent.

The at least one feedstock may be formed in an inactive state. The at least one feedstock may be formed by, for example, extrusion, mixing, compounding, melt mixing, spinning (dry, wet and jet), solution processing, and/or in-situ polymerization. In some cases, the polymeric material and fiber reinforcement may be extruded together using an extruder (e.g., a twin extruder) to render a composite feedstock material. Prior to or during extrusion, the mixed materials may be melted in the extruder. The melt blending may be performed at a temperature in which the polymers are in a fluid state. During extrusion, the composite feedstock material may be dispensed through a nozzle and squeezed to produce a composite feedstock material for additive manufacturing. Such a process can alter the physical, thermal, electrical or aesthetic characteristics of the composite feedstock material.

In some cases, polymerizing reagents (e.g., initiator and/or cross-linking agent) may be impregnated into the composite feedstock material. The impregnation process may be conducted under the activation temperature of the polymerizing reagents to prevent the composite feedstock material from cross-linking prematurely.

In some cases, continuous fibers may be coated with a polymeric resin and/or polymerizing reagents. For example, the initiator may be covalently incorporated in a portion of the polymeric material (e.g., along a backbone of the polymeric material).

In some cases, producing the composite feedstock material may comprise combining a nano-filler (e.g., carbon nanotubes), one or more of a cross-linking agent, polymerizing reagent, retarder, inhibitor, and/or neat polymer resin to form a masterbatch in a variety of forms (e.g., a filament or pellet). Next, the masterbatch may be combined with a fiber-filled polymer material to produce the composite feedstock. For example, the masterbatch may be combined with the fiber-filled polymer material during an extrusion process to form the composite feedstock. In some cases, the masterbatch may be first combined with the fiber filled polymer material to form a feedstock that may be further processed into the composite feedstock. The composite feedstock may comprise a uniform and smooth surface finish that aids in the enhancement of material properties of the composite feedstock.

The extrusion process may be performed using an extruder, such as a twin extruder, with a high ratio screw to provide a high level of shear and maximize dispersion of one or more of the nano-fillers (e.g., carbon nanotubes), cross-linking agents, retarder, inhibitor, polymerizing reagent, and/or fiber material in the polymer. Examples of dispersion techniques may comprise higher screw speed, low material throughputs, and/or the positioning of feed inlet for various components.

In some cases, producing a feedstock may comprise combining one or more of a nano-filler (e.g., carbon nanotubes), cross-linking agent, retarder, inhibitor, and/or polymerizing reagent with a fiber material together into a polymer resin (e.g., a neat polymer resin) to form the feedstock in various forms (e.g., filament or pellet). The feedstock may then be processed to form the composite feedstock material comprising a uniform and even distribution of the one or more of the cross-linking agent, retarder, inhibitor, polymerizing reagent, nano-filler (e.g., carbon nanotubes), and/or the fiber material within the polymer resin. In some cases, the combined fabricating material may be combined in a twin extruder drawing out a feedstock to be used for additive manufacturing.

Such a process can result in a uniform and smooth surface finish of the composite feedstock that aids in enhancing material properties of the composite feedstock. Additionally, such a process may result in uniform and even distribution of one or more of the nano-fillers, cross-linking agent, retarder, inhibitor, polymerizing reagent, and/or fiber within the polymer matrix of the composite feedstock.

Various combining techniques may be used to form the composite feedstock, such as compounding, melt mixing, spinning (dry, wet and jet), solution processing, and/or in-situ polymerization. In some cases, the combining process may change the physical, thermal, electrical and/or aesthetic characteristics of the composite feedstock material.

In some cases, producing the composite feedstock, may comprise coating, grafting, or growing one or more of nano-fillers (e.g., carbon nanotubes), cross-linking agent, retarder, inhibitor, and/or one or more polymerizing reagents evenly on a fiber material (e.g., surface of a fiber material) to generate a modified fiber material. The modified fiber material may be combined within a polymer resin (e.g., a neat polymer resin) and processed to produce the composite feedstock resulting in a uniform and smooth surface finish that aids in enhancing the material properties of the composite feedstock.

In some cases, combining one or more of the nano-filler, cross-linking agent, retarder, inhibitor, polymerizing reagents, and/or the fiber-filled polymer material may maximize the wettability and dispersion of these components in then composite feedstock.

The one or more nano-fillers may comprise carbon nanotubes, graphene nanoplatelets, graphite powder, and/or PTFE powder. In some cases, the fiber filled polymer material may comprise carbon fibers, glass fibers, and/or aramid fibers. The fiber material may be in the form of a milled, chopped, long discontinuous, and/or continuous fiber. In some cases, the composite feedstock may be extruded directly or compounded first and then extruded subsequently.

In some cases, a mixture of one or more of the carbon nanotubes, graphene nanoplatelets, cross-linking agents, retarder, inhibitor, and/or polymerizing reagents may be combined with the fiber material and the polymer resin to form the composite feedstock. This may optimize the mechanical strength, thermal conductivity, electrical conductivity, and ease of handling for the composite feedstock. In some cases, the fiber filled polymer material may be used in the form of pellets for extrusion, to form the composite feedstock. In some cases, the polymer resin may comprise carbon fibers, glass fibers, aramid fibers, and/or other fibers to form the fiber filled polymer.

Once the composite feedstock is formed, it may be dispensed through an opening of a print head (e.g., a nozzle) onto a base for additive manufacturing. In order to dispense a composite material with fibers in a non-aligned (e.g. random) orientation relative to each other, the nozzle can provide an expansion region through which the composite feedstock passes just prior to dispense. The expansion region comprises a random orientation of fibers dispensed from the nozzle. The expansion region may be a conduit for the composite feedstock material with a larger cross-sectional area than the cross-sectional area of the conduit immediately preceding it. In some cases, the conduit has a circular cross-section. In some cases, where the cross-section is circular, the diameter of the conduit in the expansion region exceeds that of the conduit immediately preceding it. However, other cross-section geometries may be utilized. The cross-sectional area of the expansion region may be constant. In some cases, the cross-sectional area of the nozzle may increase in the direction of flow of the feedstock through the nozzle.

The cross-linking agent may be impregnated in the coating around the composite feedstock (e.g., continuous fiber composite). The cross-linking agent may be a compound comprising at least one vinyl group. A non-limiting example of a suitable cross-linking agent is vinylsilane. The cross-linking agent may be a polymer. The cross-linking agent may have a relatively low molecular weight. In some cases, the cross-linking agent may have an average molecular weight of at most about 1000 g/mol, at most about 500 g/mol, at most about 400 g/mol, at most about 300 g/mol, at most about 200 g/mol, at most about 100 g/mol, or less. In some cases, the cross-linking agent has an average molecular weight in the range of about 100 g/mol to about 200 g/mol, about 100 g/mol to about 300 g/mol, about 100 g/mol to about 400 g/mol, or about 100 g/mol to about 500 g/mol.

The cross-linking agent may be any compound having at least two functional groups capable of reacting with the carbon-centered radicals positioned in the polymer backbone. The reaction of the cross-linking agent with the carbon-centered radical may result in a new covalent bond, thereby grafting the cross-linking molecule onto the backbone of the polymer chain.

The cross-linking agent may comprise one or more functional groups (e.g., an alkene group). In some cases, the functional groups may be CH—X moieties, in which X is a hetero atom. In some cases, the CH—X moiety may be an ether (e.g., CH—O—R, with R being an alkyl residue). In some cases, the cross-linking agent may comprise compounds with acrylic double bonds. In some cases, the cross-linking agent may comprise compounds with allylic double bonds. In some cases, the cross-linking agent may be selected from the group consisting of icosa-pentaenic acid, squalene, N,N′ methylenebisacrylamide, sorbic acid or vinyl terminated silicones.

The cross-linking agent may be polyfunctional allyl and/or acryl compounds, such as triallyl isocyanurate, trimethylpropane tricrylate or other triacrylate esters, pentaerythritol tetraacrylate, pentaerythritol triallyl ether, diallyl dimethyl ammonium chloride, triallyl cyanurate, pentaerythritol tetraallyl ether, allylmethacrylate, butanediol diacrylate, triallyl citrate, di-pentaerythritol pentaacyralate, diethyleneglycol diacrylate, di-pentaerythritol hexaacyralate, ethyleneglycol diacrylate, tetra allylorthosilicate, ethyleneglycol dimethacrylate, diallyl phthalate, triallylamine, 1,1,1-trimethylolpropane triacrylate, tetra allyloxy ethane, or triallyl amine.

In some cases, the cross-linking agent may have high molecular weight. For example, it may be advantageous in certain cases for the cross-linking agent to have a relatively high molecular weight to prevent diffusion of the cross-linking agent through the composite feedstock material. In some cases, the cross-linking agent has an average molecular weight of at least about 500 g/mol, at least about 1000 g/mol, at least about 2000 g/mol, at least about 5000 g/mol, at least about 10,000 g/mol, at least about 20,000 g/mol, at least about 50,000 g/mol, or more. The cross-linking agent may have an average molecular weight in the range of about 500 g/mol to about 1000 g/mol, about 500 g/mol to about 2000 g/mol, about 500 g/mol to about 5000 g/mol, about 500 g/mol to about 10,000 g/mol, about 500 g/mol to about 20,000 g/mol, about 500 g/mol to about 50,000 g/mol, about 1000 g/mol to about 5000 g/mol, about 1000 g/mol to about 10,000 g/mol, about 1000 g/mol to about 20,000 g/mol, about 1000 g/mol to about 50,000 g/mol, about 2000 g/mol to about 5000 g/mol, about 2000 g/mol to about 10,000 g/mol, about 2000 g/mol to about 20,000 g/mol, about 2000 g/ml to about 50,000 g/mol, about 5000 g/mol to about 10,000 g/mol, about 5000 g/mol to about 20,000 g/mol, about 20 5000 g/mol to about 50,000 g/mol, about 10,000 g/ml to about 20,000 g/mol, or about 10,000 g/mol to about 50,000 g/mol.

An initiator may be a polymerizing reagent that produces radical species under certain conditions (e.g., exposure to light and/or heat). In some cases, the one or more initiators may be selected from the group consisting of photo-initiator, a thermal initiator, and a redox initiator. The thermal initiator may be a peroxide or an azo compound. The photo-initiator may be selected from the group consisting of metal iodide, metal alkyls, and azo compounds. In some cases, the initiator may be halogen molecules (e.g., halogen initiator) or organic and inorganic peroxides. The halogen initiator may be chlorine. The azo compound may be azobisisobutyronitrile or 1,1′-azobis(cyclohexanecarbonitrile). The organic peroxide may be selected from the group consisting of di-tert-butyl peroxide, benzoyl peroxide, methyl ethyl ketone peroxide, and acetone peroxide. The inorganic peroxide may be peroxydisulfate. Alternatively, the at least one feedstock may not comprise an initiator.

Examples of initiators may include one or more of benzophenones, thioxanthones, anthraquinones, benzoylformate esters, hydroxyacetophenones, alkylaminoacetophenones, benzil ketals, dialkoxyacetophenones, benzoin ethers, phosphine oxides, acyloximino esters, alphahaloacetophenones, trichloromethyl-S-triazines, titanocenes, dibenzylidene ketones, ketocoumarins, dye sensitized photoinitiation systems, maleimides, and functional variants thereof. In some cases, the photoinitiator may comprise camphorquinone (CQ) and/or a functional variant thereof. Other examples of the initiator may comprise one or more of: 1-hydroxy-cyclohexyl-phenyl-ketone (Irgacure™ 184; BASF, Hawthorne, N.J.); a 1:1 mixture of 1-hydroxy-cyclohexyl-phenyl-ketone and benzophenone (Irgacure™ 500; BASF); 2-hydroxy-2-methyl-1-phenyl-1-propanone (Darocur™ 1173; BASF); 2-hydroxy-1-[4-(2-hydroxyethoxy)phenyl]-2-methyl-1-propanone (Irgacure™ 2959; BASF); methyl benzoylformate (Darocur™ MBF; BASF); oxy-phenyl-acetic acid 2-[2-oxo-2-phenyl-acetoxy-ethoxyl-ethyl ester; oxy-phenyl-acetic 2-[2-hydroxy-ethoxy]-ethyl ester; a mixture of oxy-phenyl-acetic acid 2-[2-oxo-2-phenyl-acetoxy-ethoxy]-ethyl ester and oxy-phenyl-acetic 2-[2-hydroxy-ethoxy]-ethyl ester (Irgacure™ 754; BASF); alpha,alpha-dimethoxy-alpha-phenylacetophenone (Irgacure™ 651; BASF); 2-benzyl-2-(dimethylamino)-1-[4-(4-morpholinyl)-phenyl]-1-butanone (Irgacure™ 369; BASF); 2-methyl-1-[4-(methylthio)phenyl]-2-(4-morpholinyl)-1-propanone (Irgacure™ 907; BASF); a 3:7 mixture of 2-benzyl-2-(dimethylamino)-1-[4-(4-morpholinyl) phenyl]-1-butanone and alpha,alpha-dimethoxy-alpha-phenylacetophenone per weight (Irgacure™ 1300; BASF); diphenyl-(2,4,6-trimethylbenzoyl) phosphine oxide (Darocur™ TPO; BASF); a 1:1 mixture of diphenyl-(2,4,6-trimethylbenzoyl)-phosphine oxide and 2-hydroxy-2-methyl-1-phenyl-1-propanone (Darocur™ 4265; BASF); phenyl bis(2,4,6-trimethyl benzoyl) phosphine oxide, which may be used in pure form (Irgacure™ 819; BASF, Hawthorne, N.J.) or dispersed in water (45% active, Irgacure™ 819DW; BASF); 2:8 mixture of phosphine oxide, phenyl bis(2,4,6-trimethyl benzoyl) and 2-hydroxy-2-methyl-1-phenyl-1-propanone (Irgacure™ 2022; BASF); Irgacure™ 2100, which comprises phenyl-bis(2,4,6-trimethylbenzoyl)-phosphine oxide); bis-(eta 5-2,4-cyclopentadien-1-yl)-bis-[2,6-difluoro-3-(1H-pyrrol-1-yl) phenyl]-titanium (Irgacure™ 784; BASF); (4-methylphenyl) [4-(2-methylpropyl) phenyl]-iodonium hexafluorophosphate (Irgacure™ 250; BASF); 2-(4-methylbenzyl)-2-(dimethylamino)-1-(4-morpholinophenyl)-butan-1-one (Irgacure™ 379; BASF); 4-(2-hydroxyethoxy)phenyl-(2-hydroxy-2-propyl)ketone (Irgacure™ 2959; BASF); bis-(2,6-dimethoxybenzoyl)-2,4,4-trimethylpentylphosphine oxide; a mixture of bis-(2,6-dimethoxybenzoyl)-2,4,4-trimethylpentylphosphine oxide and 2 hydroxy-2-methyl-1-phenyl-propanone (Irgacure™ 1700; BASF); 4-Isopropyl-9-thioxanthenone; and functional variants thereof.

In some cases, the initiator (e.g., photoinitiator) may be present in the feedstock at an amount greater than or equal to about 0.001 wt. %, 0.002 wt. %, 0.003 wt. %, 0.004 wt. %, 0.005 wt. %, 0.006 wt. %, 0.007 wt. %, 0.008 wt. %, 0.009 wt. %, 0.01 wt. %, 0.02 wt. %, 0.03 wt. %, 0.04 wt. %, 0.05 wt. %, 0.1 wt. %, 0.5 wt. %, 1 wt. %, 5 wt. %, 10 wt. %, 15 wt. %, 20 wt. %, 30 wt. %, 40 wt. %, 50 wt. %, or more. The initiator (e.g., photoinitiator) may be present in the feedstock at an amount less than or equal to about 60 wt. %, 50 wt. %, 40 wt. %, 30 wt. %, 20 wt. %, 15 wt. %, 10 wt. %, 5 wt. %, 1 wt. %, 0.5 wt. %, 0.1 wt. %, 0.05 wt. %, 0.04 wt. %, 0.03 wt. %, 0.02 wt. %, 0.01 wt. %, 0.009 wt. %, 0.008 wt. %, 0.007 wt. %, 0.006 wt. %, 0.005 wt. %, 0.004 wt. %, 0.003 wt. %, 0.002 wt. %, 0.001 wt. %, or less.

In some cases, the feedstock may further comprise a co-initiator configured to initiate polymerization from the polymeric precursor. The co-initiator may optimize the rate of polymerization from the polymeric precursor. The co-initiator may comprise primary, secondary, and tertiary amines, alcohols, and thiols. In some cases, the co-initiator may comprise ethyl-dimethyl-amino benzoate (EDMAB); 2-ethylhexyl 4-(dimethylamino)benzoate; ethyl 4-(dimethylamino)benzoate; isoamyl 4-(dimethylamino)benzoate; 2-(dimethylamino)ethyl methacrylate; 4-(dimethylamino)benzophenones, 4-(diethylamino)benzophenones; 3-(dimethylamino)propyl acrylate; methyl diethanolamine; hexane thiol; heptane thiol; octane thiol; nonane thiol; decane thiol; 4,4′-Bis(diethylamino)benzophenones; undecane thiol; dodecane thiol; triethylamine; isooctyl 3-mercaptopropionate; pentaerythritol tetrakis(3-mercaptopropionate); CN374 (Sartomer); CN371 (Sartomer); CN373 (Sartomer); Genomer 5142 (Rahn); trimethylolpropane tris(3-mercaptopropionate); 4,4′-thiobisbenzenethiol; Genomer 5161 (Rahn); Genomer (5271 (Rahn); Genomer 5275 (Rahn), TEMPIC (Bruno Boc, Germany), and/or functional variants thereof.

In some cases, the co-initiator may be present in the feedstock at an amount of at least about 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.2 wt. %, 0.3 wt. %, 0.4 wt. %, 0.5 wt. %, 1 wt. %, 2 wt. %, 3 wt. %, 4 wt. %, 5 wt. %, 6 wt. %, 7 wt. %, 8 wt. %, 9 wt. %, 10 wt. %, 15 wt. %, 20 wt. %, 30 wt. %, 40 wt. %, 50 wt. %, 60 wt. %, or more. In some cases, the co-initiator may be present in the feedstock at an amount less than or equal to about 70 wt. %, 60 wt. %, 50 wt. %, 40 wt. %, 30 wt. %, 20 wt. %, 15 wt. %, 10 wt. %, 9 wt. %, 8 wt. %, 7 wt. %, 6 wt. %, 5 wt. %, 4 wt. %, 3 wt. %, 2 wt. %, 1 wt. %, 0.5 wt. %, 0.4 wt. %, 0.3 wt. %, 0.2 wt. %, 0.1 wt. %, 0.09 wt. %, 0.08 wt. %, 0.07 wt. %, 0.06 wt. %, 0.05 wt. %, 0.04 wt. %, 0.03 wt. %, 0.02 wt. %, 0.01 wt. %, or less. In some cases, the co-initiator configured to initiate polymerization may comprise one or more functional groups that serve as a co-initiator. In some cases, the one or more functional groups may be diluted through attachment to a larger molecule. In some cases, the co-initiator may be present in the feedstock at an amount of at least about 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.2 wt. %, 0.3 wt. %, 0.4 wt. %, 0.5 wt. %, 1 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 21 wt. %, 22 wt. %, 23 wt. %, 24 wt. %, 25 wt. %, 30 wt. %, 40 wt. %, 50 wt. %, 60 wt. %, or more. The co-initiator may be present in the feedstock at an amount less than or equal to about 70 wt. %, 60 wt. %, 50 wt. %, 40 wt. %, 30 wt. %, 25 wt. %, 24 wt. %, 23 wt. %, 22 wt. %, 21 wt. %, 20 wt. %, 19 wt. %, 18 wt. %, 17 wt. %, 16 wt. %, 15 wt. %, 14 wt. %, 13 wt. %, 12 wt. %, 11 wt. %, 10 wt. %, 9 wt. %, 8 wt. %, 7 wt. %, 6 wt. %, 5 wt. %, 4 wt. %, 3 wt. %, 2 wt. %, 1 wt. %, 0.5 wt. %, 0.4 wt. %, 0.3 wt. %, 0.2 wt. %, 0.1 wt. %, 0.09 wt. %, 0.08 wt. %, 0.07 wt. %, 0.06 wt. %, 0.05 wt. %, 0.04 wt. %, 0.03 wt. %, 0.02 wt. %, 0.01 wt. %, or less.

In some cases, a retarder or inhibitor (e.g. a free-radical scavenger) may be impregnated into and/or coated onto the composite feedstock. The retarder or inhibitor can interfere with the chain initiation or chain propagation steps of the polymerization. For example, the inhibitor or retarder may react with one or more free radicals in the active state reducing or inhibiting the rate of polymerization. Retarders may be less reactive than inhibitors and may not entirely prevent initiators from reacting with monomers in a propagation reaction. In some cases, a high concentration of retarder can simulate the behavior of an inhibitor. Retarders may comprise one or more of silanols, alcohols, and/or nitro- or nitroso-derivatives of aromatic compounds. These molecules can have a strong retarding effect and can act as inhibitors. Other strong retarders or inhibitors may comprise vinyl acetate, oxygen, iodine, and/or sulfur. In some cases, the inhibitor may be selected from the group consisting of oxygen, quinone or its derivatives, sterically hindered phenol, phenolic antioxidants, phenylenediamine and phenylenediamine derivatives, and phenothiazine and its derivatives. Additionally, oxygen in the air can inhibit polymerization, particularly at the air-monomer interface.

For inhibition (e.g., photoinhibition) to occur during the 3D printing, the amount of the inhibitor (e.g., photoinhibitor) in the feedstock may be sufficient to generate inhibiting radicals at a greater rate that initiating radicals are generated. The ratio of the amount of the inhibitor and/or the initiator may be adjusted based on the optical sources' intensity available, as well as the quantum yields and light absorption properties of the initiator and/or the inhibitor in the feedstock.

In some cases, the inhibitors may suppress the polymerization reaction, by being completely consumed during an induction time before the reaction rate of polymerization assumes its normal value. The induction time may be the time between addition of the initiator and the start of the reaction (e.g., normal rate of reaction). The induction time can be linearly proportional to the amount of inhibitor added.

In some cases, retarders may be used to reduce the rate of polymerization.

The rate of reaction can steadily increase as the retarder is consumed. The equivalent induction time of a retarder may be the time that would have been required for all the retarder to be consumed if it had completely suppressed the reaction.

In some cases, the inhibitor in the feedstock may be selected from the group consisting of zinc dimethyl dithiocarbamate; zinc diethyl dithiocarbamate; zinc dibutyl dithiocarbamate; zinc dimethyl dithiocarbamate; zinc dibenzyl dithiocarbamate; tetramethylthiuram disulfide; tetraethylthiuram disulfide (TEDS); nickel dibutyl dithiocarbamate; tetrabenzylthiuram disulfide; tetraisobutylthiuram disulfide; tetramethylthiuram monosulfide; dipentamethylene thiuram hexasulfide; 3-Butenyl 2-(dodecylthiocarbonothioylthio)-2-methylpropionate; 4-Cyano-4-[(dodecylsulfanylthiocarbonyl)sulfanyl]pentanoic acid; N,N′-dimethyl N,N′-di(4-pyridinyl)thiuram disulfide; 4-Cyano-4-[(dodecylsulfanylthiocarbonyl)sulfanyl]pentanol; Cyanomethyl [3-(trimethoxysilyepropyl] trithiocarbonate; 2-Cyano-2-propyl dodecyl trithiocarbonate; Cyanomethyl dodecyl trithiocarbonate; S,S-Dibenzyl trithiocarbonate; 2-(Dodecylthiocarbonothioylthio)-2-methylpropionic acid; 2-(Dodecylthiocarbonothioylthio)-2-methylpropionic acid N-hydroxysuccinimide; Benzyl 1H-pyrrole-1-carbodithioate; Cyanomethyl methyl(4-pyridyl)carbamodithioate; 2-Cyanopropan-2-yl N-methyl-N-(pyridin-4-yl)carbamodithioate; Methyl 2-[methyl(4-pyridinyecarbamothioylthio]propionate; Cyanomethyl diphenylcarbamodithioate; Cyanomethyl methyl(phenyl)carbamodithioate; 1-Succinimidyl-4-cyano-4-[N-methyl-N-(4-pyridyl)carbamothioylthio]pentanoate; Cyanomethyl benzodithioate; 4-Cyano-4-(phenylcarbonothioylthio)pentanoic acid; Benzyl benzodithioate; 4-Cyano-4-(phenylcarbonothioylthio)pentanoic acid N-succinimidyl ester; 2-Cyano-2-propyl benzodithioate; 2-Cyano-2-propyl 4-cyanobenzodithioate; 2-Phenyl-2-propyl benzodithioate; Cyanomethyl methyl(4-pyridyl)carbamodithioate; Ethyl 2-(4-methoxyphenylcarbonothioylthio)acetate; 2-Cyanopropan-2-yl N-methyl-N-(pyridin-4-yl)carbamodithioate; 1,1′-Bi-1H-imidazole; Methyl 2-[methyl(4-pyridinyecarbamothioylthio]propionate; and functional variants thereof.

In some cases, the feedstock may comprise a stabilizer, a non-photoinhibitor, configured to inhibit formation of one or more cross-links between two or more polymer chains. In some cases, the stabilizer may or may not need separate energy (e.g., light) for activation. The stabilizer may be present in the feedstock at an amount greater than or equal to about 0.0001 wt. %, 0.0002 wt. %, 0.0003 wt. %, 0.0004 wt. %, 0.0005 wt. %, 0.0006 wt. %, 0.0007 wt. %, 0.0008 wt. %, 0.0009 wt. %, 0.001 wt. %, 0.002 wt. %, 0.003 wt. %, 0.004 wt. %, 0.005 wt. %, 0.01 wt. %, 0.05 wt. %, 0.1 wt. %, 0.5 wt. %, 1 wt. %, 2 wt. %, 3 wt. %, 4 wt. %, 5 wt. %, 10 wt. %, 15 wt. %, 20 wt. %, 25 wt. %, 30 wt. %, 40 wt. %, or more. The stabilizer may be present in the feedstock at an amount less than or equal to about 70 wt. %, 60 wt. %, 50 wt. %, 40 wt. %, 30 wt. %, 25 wt. %, 20 wt. %, 15 wt. %, 10 wt. %, 5 wt. %, 4 wt. %, 3 wt. %, 2 wt. %, 1 wt. %, 0.5 wt. %, 0.1 wt. %, 0.05 wt. %, 0.01 wt. %, 0.005 wt. %, 0.004 wt. %, 0.003 wt. %, 0.002 wt. %, 0.001 wt. %, 0.0009 wt. %, 0.0008 wt. %, 0.0007 wt. %, 0.0006 wt. %, 0.0005 wt. %, 0.0004 wt. %, 0.0003 wt. %, 0.0002 wt. %, 0.0001 wt. %, or less.

In some cases the stabilizer in the feedstock may increase the critical energy of the light for the feedstock. The stabilizer can be an inhibitor (e.g., radical inhibitor). The stabilizer may be selected from the group consisting of hydroquinoe, nitrosamine, copper-comprising compound, quinone, stable free radical (e.g., (2,2,6,6-tetramethylpiperidin-1-yl)oxidanyl), phenothiazine, copper napthalate, mequinol, t-butyl catechol, substituted phenol, butylated hydroxytoluene, Nitorosophenylhydroxylamine aluminium salt, or functional variants thereof. The inhibitor may be added to the polymeric precursor as stabilizers to prevent premature curing (e.g., polymerization, cross-linking) during handling prior to, during, or after additive manufacturing. In some cases, in at least a portion of the feedstock that is exposed to the energy source, polymerization from the polymeric precursors may not initiate until at least most of the inhibitors, are activated and consumed (e.g., by initiating radicals) in the at least the portion of the feedstock. Depending on mechanistic, steric, and/or electronic properties of the stabilizer (e.g., the inhibitor), the effect of the stabilizer on the critical energy of the photoinitiation light may vary.

In some cases, activators (e.g., photoactivated radicals) may terminate free radical polymerization, rather than initiate polymerization. The species that become the activators upon photoactivation may be used as photoinhibitors. For example, ketyl radicals may terminate rather than initiate photopolymerizations. In some cases, a polymerization process may utilize a radical species that selectively terminates growing radical chains. In some cases, the radical species may comprise sulfanylthiocarbonyl and other radicals generated in photoiniferter (e.g., photo-initiator, transfer agent, and terminator) mediated polymerizations; sulfanylthiocarbonyl radicals; and nitrosyl radicals. In some cases, lophyl radicals may be un-reactive towards polymerization of acrylates in the absence of strong chain transfer agents.

In some cases, non-radical species may be produced to terminate growing radical chains. The non-radical species may comprise various metal/ligand complexes used as deactivators in polymerization. In some cases, photoinhibitors may comprise thiocarbamates, xanthates, dithiobenzoates, hexaarylbiimidazole (HABI), photoinititators that generate ketyl and other radicals that tend to terminate growing polymer chains radicals (i.e., camphorquinone and benzophenones), deactivators, and polymeric versions thereof.

In some cases, the hexaarylbiimidazole may comprise a phenyl group with a halogen and/or an alkoxy substitution. For example, the phenyl group may comprise an ortho-chloro-substitution, an ortho-methoxy-substitution, and/or ortho-ethoxy-substitution. Examples of the functional variants of the hexaarylbiimidazole may comprise 2-(2-ethoxyphenyl)-1-[2-(2-ethoxyphenyl)-4,5-diphenyl-2H-imidazol-2-yl]-4,5-diphenyl-1H-imidazole; 2,2′-Bis(2-chlorophenyl)-4,4′,5,5′-tetraphenyl-1,2′-biimidazole; 2,2′,4-tris-(2-Chlorophenyl)-5-(3,4-dimethoxyphenyl)-4′,5′-diphenyl-1,1′-biimidazole; and/or 2-(2-methoxyphenyl)-1-[2-(2-methoxyphenyl)-4,5-diphenyl-2H-imidazol-2-yl]-4,5-diphenyl-1H-imidazole.

In some cases, the feedstock may further comprise one or more light absorbers configured shield at least a portion of the feedstock and/or a deposited layer from activation by absorbing a portion of light from an energy source. In some cases, the light absorber may be present in the feedstock at amount of at least about 0.001 wt. %, 0.002 wt. %, 0.003 wt. %, 0.004 wt. %, 0.005 wt. %, 0.006 wt. %, 0.007 wt. %, 0.008 wt. %, 0.009 wt. %, 0.01 wt. %, 0.02 wt. %, 0.03 wt. %, 0.04 wt. %, 0.05 wt. %, 0.1 wt. %, 0.5 wt. %, 1 wt. %, 5 wt. %, 10 wt. %, 15 wt. %, 20 wt. %, 30 wt. %, 40 wt. %, 50 wt. %, 60 wt. %, or more. The light absorber may be present in the feedstock at an amount less than or equal to about 60 wt. %, 50 wt. %, 40 wt. %, 30 wt. %, 25 wt. %, 20 wt. %, 15 wt. %, 10 wt. %, 5 wt. %, 1 wt. %, 0.5 wt. %, 0.1 wt. %, 0.05 wt. %, 0.04 wt. %, 0.03 wt. %, 0.02 wt. %, 0.01 wt. %, 0.009 wt. %, 0.008 wt. %, 0.007 wt. %, 0.006 wt. %, 0.005 wt. %, 0.004 wt. %, 0.003 wt. %, 0.002 wt. %, 0.001 wt. %, or less.

In some cases, the light absorber may be a dye or pigment. In some cases, the light absorber can be used to attenuate light and/or to transfer energy (e.g., via Förster resonance energy transfer (FRET)) to active species (e.g., the photoinitiator or the photoinhibitor), thereby increasing the sensitivity of the feedstock to a given wavelength suitable for the initiation and/or the inhibition process. A concentration of the light absorber may be dependent on the light absorption properties of the light absorber. In some cases, the concentration of the light absorber may be dependent on the optical attenuation from other components in the feedstock. For example, the one or more light absorbers may be used at one or more concentrations to restrict the penetration of the photoinhibition light to a given thickness such that the photoinhibition layer is thick enough to permit separation of the newly formed layer of the 3D object from the base. In some cases, the one or more light absorbers may be used at the one or more concentrations to prevent penetration and/or propagation of a photoinitiating light during fabricating at least a portion of the 3D object. In some cases, a plurality of light absorbers may be used to independently control both inhibition and initiation processes.

The light absorber may comprise compounds selected from the group consisting of 2-hydroxyphenyl-benzophenones; 2-hydroxyphenyl-s-triazines; carbon black, pthalocyanine; 2-(2-hydroxyphenyl)-benzotriazoles (and chlorinated derivatives); quinolone yellow; Penn Color Cyan; toluidine red; 9-phenyl acridine; quinacridone; 7-diethylamino-4-methyl coumarin; titanium dioxide; 2-tert-Butyl-6-(5-chloro-2H-benzotriazol-2-yl)-4-methylphenol; Sudan red, Sudan I, Sudan IV, eosin, eosin Y, neutral red, acid red, Sun Chemical UVDS 150; Martius yellow; Sun Chemical UVDS 350; Sun Chemical UVDJ107; 2-(2H-Benzotriazol-2-yl)-4,6-di-tert-pentylphenol; 9,10-Dibutoxyanthracene; and functional variants thereof.

Prior to, during, and/or subsequent to fabricating, one or more initiators may generate one or more radical species (e.g., through homolytic bond cleavage) that can directly react with a dormant functional group of the polymer, thereby activating the functional group. For example, the initiator comprising a labile bond may undergo fragmentation (e.g., photo-fragmentation). Upon irradiation, the labile bond of the initiator may break resulting in two or more radical species. The two or more radical species may be identical. As an alternative or in addition to, the two or more radical species may be different. At least one of the radical species may then react with an aliphatic C—H group positioned in the backbone of one or more polymer chain, thereby forming a carbon-centered radical in the polymer backbone of the one or more polymer chains. In some cases, two or more of the carbon-centered radical in each of the polymer chains may react with each other to form a direct covalent bond between the carbon atoms positioned in the polymer backbone in each of the polymer chains. In some cases, two or more of the carbon centered radicals comprised in monomers may react with one another other to form one or more covalent bonds a polymer chain.

In some cases, instead of abstracting a hydrogen atom from the aliphatic C—H group positioned in the backbone of the polymer chain, a carboxyl group may be abstracted from the polymer chain (decarboxylation). As a result of this reaction, a carbon-centered radical may be formed in the backbone of the polymer chain.

In some cases, a first radical species formed from the initiator may react with one or more functional groups (e.g., the alkene group) of a cross-linking agent to form a cross-linking agent radical consisting of the reaction product of the cross-linking agent and the first radical species. An aliphatic C—H group positioned in the backbone of first polymer chain may then react with the cross-linking agent radical. As a result, the reaction product may be a modified first polymer chain wherein the reaction product of the first radical species and the cross-linking agent covalently bounds to a carbon atom of the carbon-centered radical of the first polymer chain. A second radical species, formed from the initiator, may react with a second functional group of the cross-linking agent. The product of this reaction may then react with an aliphatic C—H group positioned in the backbone of second polymer chain, to form the cross-link between the first polymer chain and the second polymer chain. The cross-link may comprise the reaction product of one or more cross-linking agents comprising one or more functional groups (e.g., alkene groups) and one or more initiators.

In some cases, a cross-link between two polymer chain segments may be formed using one or more initiators undergoing reduction (e.g., photo-reduction upon irradiation). One or more initiators may undergo reduction (e.g., photo-reduction upon irradiation) to form one or more radical species. For example, the initiator may comprise carbonyl groups (e.g., ketones). Upon irradiation (e.g., UV irradiation), the initiator may be transferred in an excited state (e.g., triplet state). In such cases, the initiator may not transform into a radical, but is in a more reactive state than that prior to irradiation thereby forming an excited initiator. The excited initiator may react with an aliphatic C—H group in the backbone of a polymer chain and can abstract hydrogen, thereby forming a carbon-centered radical at this polymer chain and a ketyl radical species. In some cases, a first ketyl radical species may react with a first functional group (e.g., alkene groups) of a cross-linking agent to form a cross-linking agent radical. The cross-linking agent radical may react with the carbon-centered radicals comprised in the backbone of the one or more polymer chains. The reaction product may be a polymer chain wherein the reaction product of the first ketyl radical species and the cross-linking agent may be covalently bound to a carbon atom of the first polymer backbone. In some cases, a second ketyl radical species can react with a second functional group (e.g., alkene group) of the cross-linking agent. To form the cross-link between two polymer chains, the carbon-centered radical of the one or more polymer chains may react with another carbon centered radical in another of the one or more polymer chains through the cross-linking agent. The cross-link may comprise the reaction product of one or more cross-linking agents comprising one or more functional groups (e.g., alkene groups) and one or more initiators.

As an alternative or in addition to, two or more of the ketyl radicals can recombine with one another to form another initiator comprising a pinacol (e.g. benzpinacol) and benzophenone. In the case of initiators undergoing fragmentation (e.g., photo-fragmentation), at least a portion of the initiator is comprised by a cross-link between the polymer chains. In some cases, during reduction of initiators (e.g., photo-reduction), the initiator may be in its reduced form (e.g., a carbonyl group being reduced to a hydroxyl group) and comprised by the cross-link between the polymer chains.

In some cases, two cross-linked polymer chains may comprise one or more cross-linking agents without a portion of an initiator. The functional groups (e.g., alkene groups), which have reacted with radical species or have reacted directly with the carbon-centered radicals of the polymer chains may be converted into C—C single bonds.

In some cases, the cross-linking agents may comprise one or more functional groups (e.g., alkene group). Two or more polymer chain segments may be cross-linked to each other. In some cases, the number of functional groups comprised by the cross-linking agent may equal the number of reaction products between the initiator and the cross-linking agent.

In some cases, radical species formed from initiators may also react with carboxyl groups in the polymer chain segments. Rather than abstracting a hydrogen atom from a carbon-hydrogen bond positioned in the backbone of the polymer chain, a carboxyl group may be abstracted from the polymer chain (e.g., decarboxylation), thereby forming a carbon-centered radical in the backbone of the polymer chain.

In some cases, one or more types of cross-linking agents may be used. The cross-linking agents may be chemically the same. In some cases, two or more chemically different cross-linking agents can be used. In some cases, one or more types of activatable initiators can be used. The activatable initiators may be chemically the same. In some cases, two or more chemically different activatable initiators can be used.

In some cases, the number of available reaction sites for cross-linking may result in homogenous, uniform cross-linking. In some cases, the cross-linking agent, inhibitor, retarder, and/or polymerizing reagent may be evenly distributed along and/or in the feedstock. In some cases, the cross-linking agent, inhibitor, retarder, and/or polymerizing reagent may be applied by spraying onto the feedstock. In some cases, the cross-linking agent, inhibitor, retarder, and/or polymerizing reagent may be mixed in an appropriate concentration with a polymer compatible with the crosslinkable polymer composition.

In some cases, a radical species generated by an initiator may react with one or more other substances (e.g., cross-linking agents) present in the feedstock. For example, a first radical species generated by an initiator may react with a cross-linking agent to form a second radical species. In some cases, the second radical species may react with a dormant functional group of a polymer chain, thereby activating the functional group. As an alternative or in addition to, one or more polymerizing agents may be present in the feedstock. In some cases, the one or more polymerizing reagents may comprise a metal catalyst (e.g., a transition metal complexed with one or more ligands). A first radical species generated by an initiator may react with the metal catalyst to form a second radical species that may react with a dormant functional group of the polymer chain.

In some cases, the feedstock may comprise a polymeric material with one or more pendent cross-linking groups. At least a portion of the one or more pendent crosslinkable groups (e.g. allyl groups, acrylamide groups, and acrylate groups) may be activated, directly or indirectly, by one or more initiators. The polymeric material may comprise at least one type of repeat unit comprising a pendent crosslinkable group that may be activated by one or more initiators. In some cases, the polymer may comprise at least two types of repeat units comprising a pendent crosslinkable group that may be activated by one or more initiators. In some cases, the polymer comprising at least one type of repeat unit comprising a pendent crosslinkable group is formed through a polymerization reaction and/or post-polymerization modification.

In some cases, at least a portion of the feedstock (e.g., the α,β-unsaturated carboxylic acid monomers) may be neutralized prior to polymerization. The neutralization compounds used in neutralizing the acid groups of at least a portion of the feedstock may be used to neutralize the acid groups without affecting the polymerization process. The neutralization compounds may comprise bicarbonates, alkali metal carbonates, alkali metal hydroxides, sodium- or potassium-hydroxide, and/or sodium- or potassium-carbonate. In some cases, the carboxyl groups in the α,β-unsaturated carboxylic acid of the polymer may be at least partially neutralized. In some cases, the present methods and systems may result in the reduction of undesired side-reactions during the cross-linking processes. In some cases, the cross-linking reaction may be accomplished at temperatures of less than or equal to about 400° C., 350° C., 300° C., 250° C., 200° C., 150° C., 100° C., 90° C., 80° C., 70° C., 60° C., 50° C., 40° C., 30° C., 20° C., or less to avoid the undesired side-reactions. In some cases, the cross-linking reaction may be accomplished at temperatures of at least about 10° C., 20° C., 30° C., 40° C., 50° C., 60° C., 70° C., 80° C., 90° C., 100° C., 150° C., 200° C., 250° C., 300° C., 350° C., 400° C., or more to avoid the undesired side-reactions. During or post fabricating un-reacted cross-linking agents, initiators, and/or molecules formed by side reactions may be removed.

Inter-layer crosslinking may commence upon application of one or more elements from an energy source selected from the group consisting of heat, pressure, change in pH, radiation, and/or particle beam. Cross linking may be a stabilization process in polymer chemistry which leads to multidimensional extension of polymeric chain resulting in a network structure. A cross-link may be a bond which links one polymer chain to other. In some cases, the cross-link can be ionic or covalent, promoting differences in the polymers' physical properties.

An energy source may be a source of optical energy (e.g., laser), convective fluid (e.g., hot air), and/or resistive heating. One or more different sources of energy may be used (e.g., combination of a laser and hot air). In some cases radiation energy may be used. Methods of radiation may be selected from the group consisting of electromagnetic radiation, visible light, ultraviolet light, infrared radiation light, X-rays, gamma rays, or electron beam. In some cases, radiation crosslinking may occur at low temperatures. In some cases, the cross-linking agent may be activated by a predetermined amount of heat or radiation from an energy source. In some cases, electron beam processing can be used to cross-link a C type of cross-linked polymer (e.g. polyethylene). In some cases, cross-linked polymers can be formed by addition of a free radical molecule (e.g., peroxide) during deposition. In some cases, cross-linked polymers can be formed by addition of a cross-linking agent (e.g. vinylsilane) and/or a catalyst during extrusion, followed by post-extrusion curing.

In some cases, the feedstock and/or deposited layers may be exposed to a radiation source comprising ultraviolet- (UV-) radiation. The UV-domain of the electromagnetic spectrum may be defined between wavelengths of 100 and 380 nm and is divided into the following ranges: UV-A (315 nm-400 nm), UV-B (280 nm-315 nm), UV-C (200 nm-280 nm) and Vacuum UV (VUV) (100 nm-200 nm). UV radiation within the UV-A, UV-B or UV-C range depending on the presence, concentration and nature of a photo-initiator, commercially available mercury arcs or metal halide radiation sources can be used. The choice of the radiation source may depend on the absorption spectrum of the radical initiator and on the reactor geometry to be used. In some cases, the radiation sources may be optionally cooled (e.g., with gas) and may be embedded in or may contain a cooling component (e.g., cooling sleeve).

For example, an initiator may comprise a peroxo bridge (O-O), which can be homolytically cleaved upon application of energy (e.g., photo-fragmentation), yielding oxygen centered radicals. In some cases, the oxygen centered radicals, advantageously, may not react with the oxygen from ambient atmosphere, which can quench the reaction. In some cases, two active oxygen centered radicals may be formed from one initiator (e.g., a symmetric free radical). Each of the two oxygen centered radicals may be in close proximity allowing the carbon-centered radicals formed to be in close proximity and more easily combine to form one or more direct covalent bonds.

In some cases, a reactive intermediate species from an initiator may be ketones are transferred (e.g., upon UV irradiation) into a short-lived excited triplet state. The triplet-state ketone may abstract hydrogen from C—H bonds of C atoms positioned in the polymer backbone. In some cases, the ketone may convert into an alcohol (e.g., by photo reduction).

In some cases, an active matrix of the feedstock can be used to additively manufacture parts such that the process temperature activates the cross linking agent when depositing the material and thereby forming cross links at the layer to layer interface. In some cases, the radiation used for activation may be gamma radiation or electron beam radiation. The total dose of radiation also may be selected as a parameter in controlling the properties of the irradiated polymer. In particular, the dose of irradiation can be varied to control the degree of cross-linking and crystallinity in the irradiated polymer. In some cases, a decrease in crystallinity may result in a decrease in the elastic modulus of the polymer and consequently a decrease in the contact stress between the 3D object and a surface of another object. Lower contact stresses may be used to avoid failure of the polymer through, for instance, subsurface cracking, delamination, and fatigue. An increase in the crosslink density may also be desirable in that it results in an increase in the resistance of the polymer, which in turn reduces the wear of the 3D object made out of the crosslinked polymer and substantially reduces the amount of wear debris formed. The interlayer network of crosslinks, like a thermoset polymer, may enhance the strength on a 3D object and improve the inter-layer bonding, or a Z strength. In some cases, a melt-irradiation and subsequent cooling can result in a decrease in the crystallinity of the irradiated polymer.

The polymerizing reagent in the feedstock may comprise monomers, one or more oligomers, or both. The monomers may be configured to polymerize to form the polymeric material. The monomers may be of the different or same types. In some cases, the one or more oligomers may be configured to cross-link to form the polymeric material. An oligomer may comprise two or more monomers that are covalently linked to each other. The oligomer may be of any length, such as greater than or equal to about 2 (dimer), 3 (trimer), 4 (tetramer), 5 (pentamer), 6 (hexamer), 7, 8, 9, 10, 20, 30, 40, 50, 100, 200, 300, 400, 500, or more monomers. In some cases, the oligomer may be of a length less than or equal to about 500, 400, 300, 200, 100, 50, 40, 30, 20, 10, 9, 8, 7, 6, 5, 4, 3, 2, or less monomers.

In some cases, the polymerizing reagent may comprise dendritic precursor (e.g., monodisperse or polydisperse). The dendritic precursor may be a first generation (G1), second generation (G2), third generation (G3), fourth generation (G4), or higher with functional groups remaining on the surface of the dendritic precursor. The resulting polymeric material may comprise a monopolymer and/or a copolymer. The copolymer may be a branched copolymer or a linear copolymer. In some cases, the polymeric precursor (e.g., monomer, oligomer, or both) may comprise one or more acrylates. The copolymer may be a random copolymer, periodic copolymer, alternating copolymer, statistical copolymer, and/or block copolymer.

In some cases, the feedstock may comprise monomers at an amount from about 1 wt. % to about 80 wt. %. The feedstock may comprise monomers at an amount greater than or equal to about 1 wt. %, 2 wt. %, 3 wt. %, 4 wt. %, 5 wt. %, 6 wt. %, 7 wt. %, 8 wt. %, 9 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, or more. The feedstock may comprise monomers at an amount less than or equal to about 80 wt. %, 75 wt. %, 70 wt. %, 65 wt. %, 60 wt. %, 55 wt. %, 50 wt. %, 45 wt. %, 40 wt. %, 35 wt. %, 30 wt. %, 25 wt. %, 20 wt. %, 15 wt. %, 10 wt. %, 9 wt. %, 8 wt. %, 7 wt. %, 6 wt. %, 5 wt. %, 4 wt. %, 3 wt. %, 2 wt. %, 1 wt. %, or less. In some cases, the feedstock may not comprise any monomers. For example, the feedstock may comprise one or more oligomers.

The monomers may comprises one or more of hydroxyethyl methacrylate; 2,2,2-trifluoroethyl methacrylate; isobornyl methacrylate; polypropylene glycol monomethacrylates, aliphatic urethane acrylate (i.e., Rahn Genomer 1122); n-Lauryl acrylate; tetrahydrofurfuryl methacrylate; hydroxyethyl acrylate; tetrahydrofurfuryl acrylate; 2,2,2-trifluoroethyl acrylate; isobornyl acrylate; n-Lauryl methacrylate; polypropylene glycol monoacrylates; trimethylpropane trimethacrylate; pentaerythritol tetraacrylate; trimethylpropane triacrylate; pentaerythritol tetraacrylate; triethylene glycol dimethacrylate; tetrathyleneglycol diacrylate; triethyleneglycol diacrylate; tetrathylene glycol dimethacrylate; neopentylacrylate; hexane dioldimethacylate; neopentyldimethacrylate; hexane diol diacrylate; polyethylene glycol 400 diacrylate; diethylglycol diacrylate; diethylene glycol dimethacrylate; polyethylene glycol 400 dimethacrylate; ethyleneglycol diacrylate; ethoxylated bis phenol A dimethacrylate; ethylene glycol dimethacrylate; ethoxylated bis phenol A diacrylate; bisphenol A glycidyl acrylate; ditrimethylolpropane tetraacrylate; bisphenol A glycidyl methacrylate; ditrimethylolpropane tetraacrylate; and functional variants thereof. In some cases, the monomers may comprise (i) phenoxy ethyl acrylate or a functional variant thereof, or (ii) tricyclodecanediol diacrylate, or a functional variant thereof.

In some cases, the feedstock may comprise one or more oligomers at an amount from about 1 wt. % to about 30 wt. %. The feedstock may comprise one or more oligomers at an amount greater than or equal to about 1 wt. %, 2 wt. %, 3 wt. %, 4 wt. %, 5 wt. %, 6 wt. %, 7 wt. %, 8 wt. %, 9 wt. %, 10 wt. %, 15 wt. %, 20 wt. %, 25 wt. %, 30 wt. %, or more. The feedstock may comprise one or more oligomers at an amount less than or equal to about 30 wt. %, 25 wt. %, 20 wt. %, 15 wt. %, 10 wt. %, 9 wt. %, 8 wt. %, 7 wt. %, 6 wt. %, 5 wt. %, 4 wt. %, 3 wt. %, 2 wt. %, 1 wt. %, or less. In some cases, the feedstock may not comprise one or more oligomers. For example, the feedstock may comprise the monomers.

In some cases, the one or more oligomers may comprise one or more of: dendritic (meth)acrylate; polyether; polyester; Esstech Exothane 108; epoxy; urethane; polyol; polybutadiene; phenolic based acrylates; silicon; methacrylates; polyester urethane (meth)acrylate; polyol (meth)acrylate; Esstech Exothane 126; thioether; phenolic (meth)acrylate; urethane (meth)acrylate; epoxy(meth)acrylate; Sartomer CN9009; silicone (meth)acrylate; polybutadiene (meth)acrylate; polyether (meth)acrylate; or a functional variant thereof.

In some cases, the feedstock may further comprise one or more particles. The one or more particles may comprise any particulate material (e.g., a particle) that can be sintered or melted (e.g., not completely melted). In some cases, the particulate material may be in powder form. The particular material may be an inorganic material. The inorganic material may be ceramic materials, metallic, intermetallic, or any combination thereof. The one or more particles may comprise at least one intermetallic material, at least one metallic material, at least one ceramic material, or any combination thereof.

The metallic materials for the one or more particles may include one or more of manganese, calcium, aluminum, titanium, vanadium, scandium, barium, iron, cobalt, nickel, copper, magnesium, yttrium, chromium, niobium, zinc, molybdenum, silver, ruthenium, cadmium, rhodium, actinium, and gold. In some cases, the particles may comprise a rare earth element, such as one or more of scandium, yttrium, and elements of the lanthanide series having atomic numbers from 57-71.

An intermetallic material for the one or more particles may be a solid-state compound comprising defined stoichiometry, metallic bonding, and ordered crystal structure (e.g., alloys). In some cases, the intermetallic materials may be in prealloyed powder form. For example, the prealloyed powders may comprise brass (copper and zinc), copper, duralumin (aluminum, manganese, and/or magnesium), nichrome (nickel and chromium), gold alloys (gold and copper), bronze (copper and tin), rose-gold alloys (gold, copper, and zinc), and stainless steel (e.g., carbon, iron, and additional elements comprising manganese, molybdenum, nickel, boron, silicon, chromium, vanadium, tungsten, titanium, cobalt, and/or niobium). In some cases, the prealloyed powders may comprise superalloys. For example, the superalloys may be based on elements comprising titanium, iron, cobalt, chromium, nickel, tungsten, tantalum, niobium, molybdenum, and/or aluminum.

In some cases, the ceramic materials may comprise non-metal (e.g., nitrogen, oxygen), metal (e.g., aluminum, titanium), and/or metalloid (e.g., silicon, germanium) atoms primarily held in covalent and/or ionic bonds. The ceramic materials may comprise an hydroxide, aluminide, beryllia, carbide, titania zirconia, nitride, boride, kyanite, chromium oxide, sulfide, mullite, ferrite, yttria, and magnesia.

In some cases, the feedstock may comprise a pre-ceramic material. The pre-ceramic material may be a polymer that may heat (or pyrolyzed) to form a ceramic material. The pre-ceramic material may comprise 1,3-bis(3-carboxypropyl)tetramethyldisiloxane; 1,3,5,7-tetraethyl-2,4,6,8-tetramethylcyclotetrasilazane; polysiloxanes, aluminum III diisopropoxide-ethylacetoacetate; polyorganozirconates, tris(trimethylsilyl)phosphate; polycarbosilanes, polyorganoaluminates, polysilazanes, polyborosilanes, zirconium tetramethacrylate, zirconyl dimethacrylate, or zirconium 2-ethylhexanoate; polysilanes, aluminum III s-butoxide, 1,3-bis(chloromethyl) 1,1,3,3-Tetrakis(trimethylsiloxy)disiloxane; tris(trimethylsiloxy)boron; and mixtures thereof.

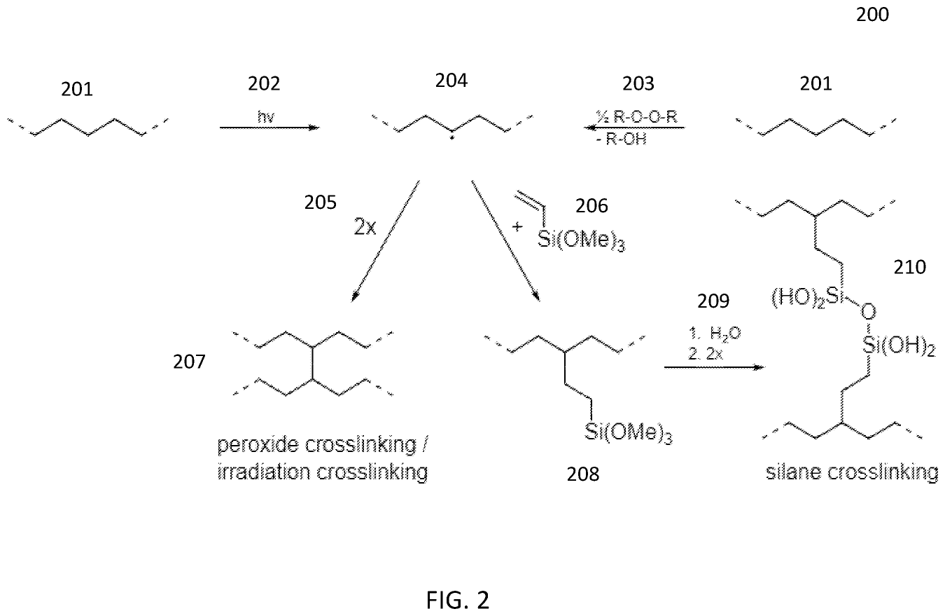

FIG. 2 illustrates an example of a reaction scheme 200 for forming interlayer crosslinks. FIG. 2 shows a polymeric material 201 that is in an inactive state. The polymer material 201 may be exposed to an energy source 202 to form an activated polymer radical 204, thus providing the polymer material 201 in an active state. The energy source 202 may provide light (hv as shown), such as ultraviolet (UV) light. Alternatively, the polymer material 201 may be activated upon contact with initiator 203 to form an activated polymer material 204. The activated polymer material 204 may include at least one radical. The initiator 203 may be peroxide (ROOR as shown, wherein ‘R’ denotes hydrogen or a carbon-containing moiety), in which case peroxide-mediated activation of the polymer material 201 to yield the activated polymer material 204 may yield an alcohol (ROH as shown, wherein ‘R’ denotes hydrogen or a carbon-containing moiety).

The activated polymer material 204 may react with other material (e.g., another polymer material 201 or another polymer). For example, a polymer radical of the activated polymer material 204 may react along reaction pathway 205 with a polymer radical of another activated polymer material to form a cross-linked product 207. Reaction pathway 205 may be facilitated by energy from an energy source, such as light (e.g., UV light).

Alternatively, the polymer radical 204 may react along reaction pathway 206 with a cross-linking agent to form an intermediate molecule 208. The cross-linking agent may be, for example, vinylsilane or a derivative of vinylsilane (derivative shown). Next, the intermediate molecule 208 may undergo at least one round (e.g., two times as shown) of a hydration reaction 209 (H₂O as shown) with another intermediate molecule having a structure similar or identical to the intermediate molecule 208 to from one or more interlayer silane cross-linked product 210.

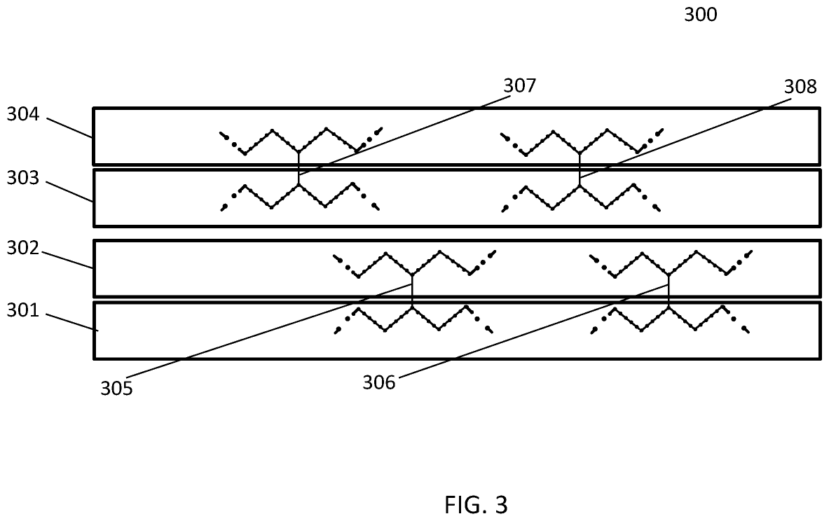

FIG. 3 illustrates an example of a schematic 300 comprising selective inter-layer cross-linking. FIG. 3 shows several layers of deposited feedstock adjacent to one another. A first layer 301 adjacent to a second layer 302 comprises activated polymer chain segments that have been cross-linked at positions 305 and 306 at an interface between the first layer 301 and the second layer 302. A third layer 303 adjacent to a fourth layer 304 also comprises activated polymer chain segments that have been cross-linked at positions 307 and 308 at an interface between the third layer 303 and the fourth layer 304. In contrast, the interface between the second layer 302 and the third layer 303 does not contain activated polymer chain segments and as a result does not contain interlayer crosslinking.

In some cases, the polymer material in the feedstock may comprise the same type of polymer. Alternatively, the polymer material may comprise a mixture of different types of polymers (e.g., polymers with different functional groups).

In some cases, more than one method of activation may be utilized. The sequence of the activation methods may be set to achieve a particular result.

Selective inter-layer cross-linking may be achieved using controlled manipulation of polymers through radiation chemistry (e.g., radiation shielding). In some cases, at least a portion of the 3D object may be shielded from activation. For example, the degree of crosslinking within one portion of the 3D object may vary by shielding parts of the 3D object during irradiation. In some cases, the at least one feedstock may comprise an inhibitor that shields at least a portion of the feedstock from heat and/or the radiation. By using a shield made of selected materials, thicknesses, geometries, areas and utilization of the shields in a selected order, the overall properties of an irradiated polymer may be controlled and tailored to achieve the result. This may be done particularly in view of alterations that can be made in the type of irradiation, the irradiation dose, dose rate, exposure time, temperature, and the methodology used. The irradiation shield may be made from any material that will at least shield in part the polymer from the irradiation. The shield material may be selected from the group consisting of ceramics, metals, and glass. The ceramics may include alumina and/or zirconia. The metals may be selected from the group consisting of aluminum, lead, iron, and steel. Polymers also may be used as shields. An irradiation shield may be provided in any shape, cross-section, or thickness. For example, the thickness of the shield can contribute to the ability of the shield material to shield the irradiation. Accordingly, the thickness of the shield can be selected depending upon the extent of shielding that is predetermined in the shielded portion. In this manner, the depth of irradiation penetration can be controlled, or a total shielding of irradiation of the covered areas can be achieved.

In some cases, an iso-dose penetration and a dose-depth penetration profile may depend on the energy of the electrons used. The iso-dose penetration may be the depth at which the dose equals that at the e-beam incidence surface. Accordingly, the effect of irradiation and shielding can be controlled through one or more parameters selected from the group consisting of the materials used in the shield, the thickness of the shield (constant or variable), the extent to which the shield covers the area of the material being irradiated (full or partial), the order of shielding and irradiation, the type and extent of irradiation, and/or polymer selection.

In some cases, a shape and cross-section of the shield can also determine the properties of the irradiated polymer. Any shape and cross-section shield, or combination of shapes and cross-sections, may be utilized to achieve a predetermined cross-link depth and pattern. Full coverage shielding, denoting the use of a shield that covers the entire surface of the polymer being irradiated, may be characterized by a cross-linking gradient parallel to the direction of irradiation. That is, due to the shield (including, for example, a portion of the polymeric material itself), there may be differences in the degree of cross-linking in the plane of the at least a portion of the 3D object that is parallel to the vector that defines the direction of the radiation from the source to the 3D object. The degree of cross-linking can affect a gradient ranging from extensively cross-linked to non-cross-linked.

In some cases, partial coverage shielding may be characterized by a cross-linking gradient perpendicular to the direction of irradiation. That is, due to the shield, there may be differences in the degree of crosslinking in the plane of the at least a portion of the 3D object that is perpendicular to the vector that defines the direction of the radiation from the source to the 3D object. During partial coverage shielding, the shield may not cover the entire surface of the polymer being irradiated. Cross-linking may be the most prevalent in the unshielded areas. Cross-linking may begin to decrease at the interface of the shield and an unshielded (or lesser shielded) edge, and decrease further, or be absent altogether (depending upon the thickness and consistency of the shield), at the inner portions under the shielded area.

In some cases, following fabricating of the 3D object, one or more post-processing methods may be utilized to finish the 3D object. The post-processing method may be selected from the group consisting of further irradiation, infiltration, bakeout, and/or firing. This step may accelerate curing of feedstock components (e.g., binder) to reinforce the 3D object, removal of curing/cured binder (e.g., by decomposition), consolidation of core polymeric material (e.g., by sintering/melting), and/or formation of a composite material blending the properties of powder and binder. In some cases, the step may further comprise heating or irradiating the at least partially cured layers to accelerate the cure.

Depending on the polymer or polymer alloy used, and whether the polymer was irradiated below its melting point, there may be residual free radicals left in the polymeric material following the irradiation process. A polymer irradiated below its melting point (e.g., with ionizing radiation) may comprise cross-links as well as long-lived trapped free radicals. Some of the free radicals generated during irradiation can become trapped at crystalline lamellae surfaces. If there are residual free radicals remaining in the material, they may be reduced to substantially undetectable levels, as measured by various tests (e.g., electron spin resonance), through annealing (e.g., melt annealing) of the polymer above the melting point of the polymeric system used. During annealing, residual free radicals may recombine with each other. If for a given system the 3D object does not have substantially any detectable residual free radicals following irradiation, then the annealing step may be omitted. Also, if for a given system the concentration of the residual free radicals is low enough to not lead to degradation, the annealing step may be omitted. In some of the lower molecular weight and lower density polymeric materials, the residual free radicals may recombine with each other even at room temperature over short periods of time (e.g. few hours to few days, to few months). In such cases, subsequent annealing may be omitted if the increased crystallinity and modulus resulting from the irradiation is sought after. Otherwise, the subsequent annealing may be carried out to decrease the crystallinity and modulus.

The reduction of free radicals can be achieved by heating the polymer to above the melting point. The heating can provide the molecules with sufficient mobility so as to eliminate the constraints derived from the crystals of the polymer, thereby allowing essentially all of the residual free radicals to recombine. The polymer may be heated to a temperature between the peak melting temperature and degradation temperature of the polymer. The temperature in the heating step may be maintained for about 0.5 min to about 24 hrs, about 1 hr to about 3 hrs, or about 5 hr to about 15 hrs. The heating can be carried out in air, an inert gas (e.g., nitrogen, argon or helium), a sensitizing atmosphere (e.g., acetylene), or a vacuum. For the longer heating times, the heating may be performed in an inert gas or under vacuum to avoid in-depth oxidation. In some cases, there may be a tolerable level of residual free radicals in which case, the post-irradiation annealing can also be carried out below the melting point of the polymer.

In some cases, thermal properties of the polymers may be determined using differential scanning calorimetry (DSC) at various heating and cooling rates. This aids in determining the parameters in the thermodynamic analysis of the activation process for each polymer or polymer alloy. The heats of fusion, specific heats, crystallization, peak melting temperatures and crystallization temperatures may be determined from the first heating and cooling endotherms. In some cases, the cooling profile may be monitored to determine the variations in the crystallization behavior of the test samples. Cross-link densities, infra-red analyses, and/or other analytical techniques also may be performed on irradiated samples.

The methods and systems may be performed using various materials. The feedstock may comprise filaments, sheets, powders, and/or inks. In some examples, a material that may be used in 3D printing includes a polymeric material, elemental metal, metal alloy, a ceramic, composite material, an allotrope of elemental carbon, or a combination thereof. The allotrope of elemental carbon may comprise amorphous carbon, graphite, graphene, diamond, or fullerene. The fullerene may be selected from the group consisting of a spherical, elliptical, linear, tubular fullerene, and any combination thereof. The fullerene may comprise a Bucky ball or a carbon nanotube. The material may comprise an organic material, for example, a polymer or a resin. The material may be a solid material or a liquid material. In some cases, the material may comprise one or more strands or filaments. The solid material may comprise powder material. The powder material may be coated by a coating (e.g., organic coating such as the organic material (e.g., plastic coating)). The powder material may comprise sand. The material may be in the form of a powder, wire, pellet, or bead. The material may have one or more layers. The material may comprise at least two materials. In some cases, the material includes a reinforcing material (e.g., that forms a fiber). The reinforcing material may comprise a carbon fiber, Kevlar, Twaron, ultra-high-molecular-weight polyethylene, or glass fiber. In some cases, the filament material comprises one or more elements selected from the group consisting of continuous fiber, long fiber, short fiber, and milled fiber.

If used, the core of the continuous fiber composite may be selected to provide any predetermined property. Appropriate core fiber or strands include those materials which impart a predetermined property, such as structural, conductive (electrically and/or thermally), insulative (electrically and/or thermally), optical and/or fluidic transport. Such materials may comprise carbon fibers, aramid fibers, fiberglass, metals (such as copper, silver, gold, tin, and steel), optical fibers, and/or flexible tubes. The core fiber or strands may be provided in any appropriate size. Further, multiple types of continuous cores may be used in a single continuous core reinforced filament to provide multiple functionalities such as electrical and optical properties. A single material may be used to provide multiple properties for the core reinforced filament. For example, a steel core may be used to provide both structural properties as well as electrical conductivity properties.

Feedstock for 3D printing may be formed of a plurality of filaments, such as at least 10, 100, 200, 300, 400, 500, 1000, 10000, 100000, 1000000, or more. In some cases, the feedstock for 3D printing may be formed of a plurality of filaments, such as at most about 1000000, 100000, 10000, 1000, 500, 400, 300, 200, 100, 10, or less. The feedstock may be formed of different types of filaments, such as a first filament formed of a polymeric material and a second filament formed of a reinforcing material. The feedstock material may incorporate one or more additional materials, such as resins and polymers. The polymeric material may comprise one or more elements selected from the group consisting of polyethylene, polyamide, polybutylene terephthalate, polyvinyl chloride, polypropylene, and thermoplastic elastomer. The polymeric material may be a thermosetting polymer. In some examples, the polymeric material is selected from the group consisting of acrylonitrile butadiene styrene (ABS), epoxy, vinyl, nylon, Liquid Crystal Polymer, polyaryletherketone (PAEK), polyethertherketone (PEEK), polyetherketoneketone (PEKK), polyethylene (PE), polyetherimide (PEI), polyethersulfone (PES), polysulfone (PSU), polyphenylsulfone (PPSU), polyphenylene oxides (PPOs), acrylonitrile butadiene styrene (ABS), polylactic acid (PLA), polyglycolic acid (PGA), polyamide-imide (PAI), polystyrene (PS), polyamide (PA), polybutylene terephthalate (PBT), poly(p-phenylene sulfide) (PPS), polyethersulfone (PESU), polyphenylene ether, polyimide, polycarbonate (PC), polyethylenimine, polytetrafluoroethylene, polyvinylidene, and various other thermoplastics. The reinforcing material may be a carbon-based material, such as carbon nanotubes, graphene, Bucky balls, metallic materials (e.g., steel), or a combination thereof.

In some cases, the polymer (e.g., polymer resins) may be combined together to improve the printability and fiber/nano-filler wettability. One such example is a blend of polyethertherketone (PEEK) with polyphenylsulfone (PPSU) with a composition in the range of 60:40 to 90:10 respectively. In some cases, the amount of fiber or carbon nanotube or other nano-filler material in the polymer resins may range from 5% up to 60%. For example, a composition of polyetherimide (PEI) and polyethertherketone (PEEK) resins may comprise 30% CNT loading, 15% CNT and 15% CF, 10% CNT and 10% CF (Carbon Fiber). A blend of 15% CNT and 15% graphene may also be combined in the above thermoplastic resins. In some cases, one may change the loading of CNT and graphene from as low as 1% CNT or graphene up to as high as 40% graphene or CNT.

In some cases, a feedstock may be produced by using carbon nanotubes or other nano-fillers. Carbon nanotubes may provide a smoother, more uniform material surface. This smooth, uniform surface may result in decreased nozzle pressure during fabricating, improved ease of handling, potentially better material properties, and potentially improved z-layer adhesion (due to the higher surface area contact from smoother extrudate surfaces). Furthermore, with its three dimensional structure, carbon nanotubes may be more likely to be aligned through the fabricating process. In some cases, a smooth uniform extrudate surface for additive manufacturing may be achieved which enables achievement of high possible material properties. Also, the surface roughness and diameter fluctuations may be reduced when adding carbon nanotubes with carbon fiber as compared to only carbon fiber. In some cases, a polymer material including a blend of carbon nanotubes or other nano-fillers and fibers may provide a smoother, more uniform surface, a more flexible, easier to handle feedstock. In some cases, a smoother and more uniform extrudate for additive manufacturing may be developed.

Various modifiers within the layers themselves may be used which are selectively printed onto specific regions of the 3D object in order to impart various desirable mechanical, chemical, magnetic, electrical or other properties to the 3D object. Such modifiers may be selected from the group consisting of thermal conductors and insulators, dielectric promoters, electrical conductors and insulators, locally-contained heater traces for multi-zone temperature control, batteries, and sensors. In some cases, at least one print head can be may be used for fabricating such modifiers. As predetermined, such modifiers can be printed before at least a first energy beam is directed onto at least a portion of the first layer and/or second layer. Alternatively, such modifiers may be printed over a layer that has been melted, before filament material for the next layer is deposited.

Following fabricating of the at least a portion of the 3D object, the crosslinking in the at least a portion of the 3D object may be measured using various methods, such as swelling experiments. For example, the crosslinked sample (e.g., at least a portion of the 3D object) may be may be placed into a solvent at a predetermined temperature. Next, a change in volume or mass may be measured. The amount of cross-linking may be inversely proportional to the degree of swelling. After determining the degree of swelling, a Flory Interaction Parameter and the density of the solvent may be used to calculate the theoretical degree of crosslinking according to various techniques (e.g., Flory's Network Theory, Flory-Rehner equation). The Flory Interaction Parameter may relate to the solvent interaction with the sample.

In some cases, various American Society for Testing and Materials (ASTM) standards may be used to determine and indicate the degree of crosslinking in the sample. For example, in ASTM D2765, the sample may be weighed, and placed in a solvent for 24 hours. Next, the sample may be weighed while swollen, then dried and weighed again. The soluble portion and the degree of swelling may then be calculated. In another example, for the ASTM standard, F2214, the sample may be placed in an instrument that determines and measures the change in height of the sample. This allows the user to determine and measure the volume change, which may be used to calculate the crosslink density.

In some cases, microscopy techniques (e.g., the scanning electronic microscope (SEM)) may be used to determine a density of cross-linking. Mechanical testing methods may provide parameters (e.g., the uniaxial or shear modulus) that can be used to indicate the crosslinking density. In some cases, elemental analysis, gel-fraction methods, nuclear magnetic resonance (NMR) relaxation, and/or diffusion experiments may be used to determine the crosslinking density.

### Computer Control Systems

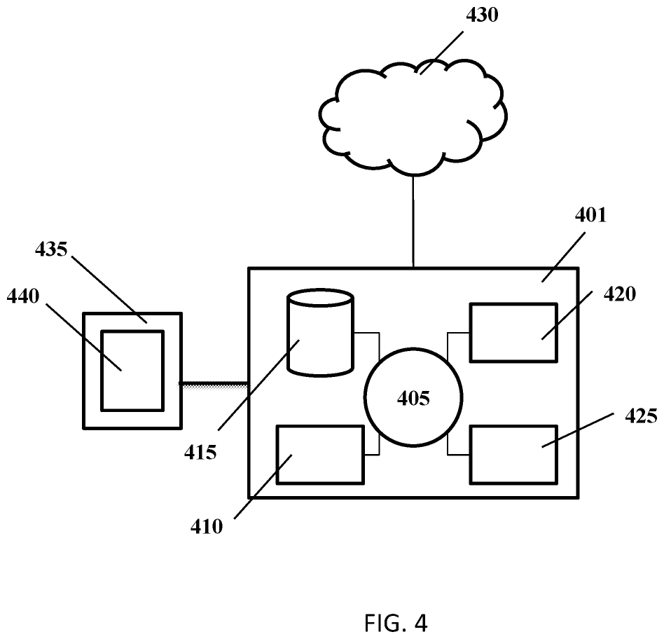

The present disclosure provides computer control systems that are programmed to implement methods of the disclosure. FIG. 4 shows a computer system 401 that is programmed or otherwise configured to implement 3D printing methods provided herein. The computer system 1101 can regulate various aspects of methods of the present disclosure, such as, for example, direct interlayer activation of the cross-linking agent. The computer system 401 can be an electronic device of a user or a computer system that is remotely located with respect to the electronic device. The electronic device can be a mobile electronic device.

The computer system 401 includes a central processing unit (CPU, also “processor” and “computer processor” herein) 405, which can be a single core or multi core processor, or a plurality of processors for parallel processing. The computer system 401 also includes memory or memory location 410 (e.g., random-access memory, read-only memory, flash memory), electronic storage unit 415 (e.g., hard disk), communication interface 420 (e.g., network adapter) for communicating with one or more other systems, and peripheral devices 425, such as cache, other memory, data storage and/or electronic display adapters. The memory 410, storage unit 415, interface 420 and peripheral devices 425 are in communication with the CPU 405 through a communication bus (solid lines), such as a motherboard. The storage unit 415 can be a data storage unit (or data repository) for storing data. The computer system 401 can be operatively coupled to a computer network (“network”) 430 with the aid of the communication interface 420. The network 430 can be the Internet, an internet and/or extranet, or an intranet and/or extranet that is in communication with the Internet. The network 430 in some cases is a telecommunication and/or data network. The network 430 can include one or more computer servers, which can enable distributed computing, such as cloud computing. The network 430, in some cases with the aid of the computer system 401, can implement a peer-to-peer network, which may enable devices coupled to the computer system 401 to behave as a client or a server.

The CPU 405 can execute a sequence of machine-readable instructions, which can be embodied in a program or software. The instructions may be stored in a memory location, such as the memory 410. The instructions can be directed to the CPU 405, which can subsequently program or otherwise configure the CPU 405 to implement methods of the present disclosure. Examples of operations performed by the CPU 405 can include fetch, decode, execute, and writeback.

The CPU 405 can be part of a circuit, such as an integrated circuit. One or more other components of the system 401 can be included in the circuit. In some cases, the circuit is an application specific integrated circuit (ASIC).

The storage unit 415 can store files, such as drivers, libraries and saved programs. The storage unit 415 can store user data, e.g., user preferences and user programs. The computer system 401 in some cases can include one or more additional data storage units that are external to the computer system 401, such as located on a remote server that is in communication with the computer system 401 through an intranet or the Internet.

The computer system 401 can communicate with one or more remote computer systems through the network 430. For instance, the computer system 401 can communicate with a remote computer system of a user (e.g., customer or operator of a 3D printing system). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 401 via the network 430.

Methods as described herein can be implemented by way of machine (e.g., computer processor) executable code stored on an electronic storage location of the computer system 401, such as, for example, on the memory 410 or electronic storage unit 415. The machine executable or machine readable code can be provided in the form of software. During use, the code can be executed by the processor 405. In some cases, the code can be retrieved from the storage unit 415 and stored on the memory 410 for ready access by the processor 405. In some situations, the electronic storage unit 415 can be precluded, and machine-executable instructions are stored on memory 410.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 401 can include or be in communication with an electronic display 435 that comprises a user interface (UI) 440 for providing, for example, a print head tool path to a user. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 405. The algorithm can, for example, direct interlayer activation of the cross-linking agent.

The computer system 401 can include a 3D printing system. The 3D printing system may include one or more 3D printers. A 3D printer may be, for example, a fused filament fabrication (FFF) printer. Alternatively or in addition to, the computer system 401 may be in remote communication with the 3D printing system, such as through the network 430.

### Examples

In an example, prior to fabricating the 3D object, a request for production of a requested 3D object is received from a user (e.g., customer). A model of the 3D object may be received in computer memory. Next, a composite filament material comprising a cross-linking agent may be directed from a spool toward a channel of the print head. The filament material may then be directed through a nozzle towards a base that is configured to support the 3D object. A first layer may be deposited corresponding to a portion of the 3D object adjacent to the base. The first layer in the X and Y direction may be deposited in accordance with the model of the 3D object. Additional layers may be deposited onto the first layer in the Z direction. After deposition, a portion of an additional layer and a portion of a previous layer may be irradiated to activate the interlayer cross-linking agent.

The system may comprise a heater cartridge with thermal control from PID controllers connected to sensors, such as one or more thermocouples and/or one or more optical thermal sensors (e.g., pyrometer). During deposition, the heater cartridges may control heating and/or the temperature for the system in accordance with the parameters for building the model of the 3D object. The sensors may provide feedback to the PID controller and may maintain temperature set points throughout the build process. A laser beam (or other heater) may then be used to activate several portions of the 3D object, thereby forming crosslinks at the layer to layer interface. A part of the modulated laser beam may be focused by the focusing system, and irradiated along the filament material for three-dimensional fabricating. The 3D object may be allowed to cool prior to removing the object from the substrate. The 3D object may be packaged and then delivered to the customer.

Examples of methods, systems and materials that may be used to create or generate objects or parts herein are provided in U.S. Patent Publication Nos. 2014/0232035, 2016/0176118, and U.S. patent application Ser. Nos. 14/297,185, 14/621,205, 14/623,471, 14/682,067, 14/874,963, 15/069,440, 15/072,270, 15/094,967, each of which is entirely incorporated herein by reference.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for fabricating at least a portion of a three-dimensional (3D) object, comprising:
(a) using a fabricating unit to direct at least one feedstock from a source of said at least one feedstock towards a base, wherein said at least one feedstock comprises a polymeric material and a cross-linking agent, which cross-linking agent is in an inactive state; and
(b) using said fabricating unit to deposit a first layer of said at least one feedstock adjacent to a second layer previously deposited adjacent to said base, wherein said first layer corresponds to at least a portion of said 3D object, wherein during or subsequent to deposition adjacent to said second layer, said cross-linking agent in said first layer is in an active state to induce cross-linking between said polymeric material in said first layer and a polymeric material in said second layer.

2. The method of claim 1, wherein said second layer is formed from said at least one feedstock, and wherein said second layer comprises said cross-linking agent and said polymeric material, wherein said cross-linking agent of said second layer is in an active state subsequent to deposition.

3. The method of claim 2, further comprising repeating (b) one or more times for deposition of additional layer(s) to form said 3D object.

4. The method of claim 1, further comprising, prior to (a), combining said cross-linking agent with said polymeric material in said inactive state to form said at least one feedstock.

5. The method of claim 4, further comprising impregnating a thermo-initiator or a photo-initiator into said at least one feedstock.

6. The method of claim 1, wherein said at least one feedstock comprises an initiator.

7. The method of claim 6, wherein said initiator is a thermo-initiator or a photo-initiator.

8. The method of claim 1, wherein said at least one feedstock does not comprise an initiator.

9. The method of claim 1, wherein said at least one feedstock is a continuous fiber composite.

10. The method of claim 1, wherein said polymeric material is an unpolymerized resin or a partially polymerized resin.

11. The method of claim 1, wherein said polymeric material comprises one or more elements selected from the group consisting of polyethylene, polyamide, polybutylene terephthalate, polyvinyl chloride, polypropylene, and thermoplastic elastomer.

12. The method of claim 1, wherein said cross-linking agent comprises one or more elements selected from the group consisting of organo-functional silane, phenylene diamine, and triallyl cyanurate (TAC).

13. (canceled)

14. (canceled)

15. (canceled)

16. (canceled)

17. (canceled)

18. A system for fabricating at least a portion of a three-dimensional (3D) object, comprising:
a source of at least one feedstock that is configured to supply at least one feedstock for generating said at least said portion of said 3D object;
a base for supporting said at least said portion of said 3D object;
a fabricating unit that is configured to direct said at least one feedstock from said source of said at least one feedstock towards said base; and
one or more computer processors operatively coupled to said fabricating unit, wherein said one or more computer processors are individually or collectively programmed to:
(i) direct said fabricating unit to direct said at least one feedstock from said source of said at least one feedstock towards said base, wherein said at least one feedstock comprises a polymeric material and a cross-linking agent, which cross-linking agent is in an inactive state, and
(ii) direct said fabricating unit to deposit a first layer of said at least one feedstock adjacent to a second layer previously deposited adjacent to said base, wherein said first layer corresponds to said at least said portion of said 3D object, wherein during or subsequent to deposition adjacent to said second layer, said cross-linking agent in said first layer is in an active state to induce cross-linking between said polymeric material in said first layer and a polymeric material in said second layer.

19. The system of claim 18, wherein said one or more computer processors are individually or collectively programmed to repeat (ii) one or more times for deposition of additional layer(s) to form said at least said portion of said 3D object.

20. The system of claim 18, wherein said at least one feedstock comprises an initiator.

21. The system of claim 20, wherein said initiator is a thermo-initiator or a photo-initiator.

22. The system of claim 18, wherein said at least one feedstock does not comprise an initiator.

23. The system of claim 18, wherein said at least one feedstock is a continuous fiber composite.

24. The system of claim 18, wherein said polymeric material is an unpolymerized resin or a partially polymerized resin.

25. The system of claim 18, wherein said polymeric material comprises one or more elements selected from the group consisting of polyethylene, polyamide, polybutylene terephthalate, polyvinyl chloride, polypropylene, and thermoplastic elastomer.

26. (canceled)

27. (canceled)

28. (canceled)

29. (canceled)

30. (canceled)

31. (canceled)
